(19) United States
(12) Patent Application Publication
(10) Pub. No.: US 2025/0300709 A1
(43) Pub. Date: Sep. 25, 2025

(54) UPLINK CONTROL INFORMATION PACKING AND PRIORITIZATION FOR CHANNEL STATE INFORMATION

(71) Applicant: QUALCOMM Incorporated, San Diego, CA (US)

(72) Inventors: Min HUANG, Beijing (CN); Jing DAI, Beijing (CN); Chao WEI, Beijing (CN); Sony AKKARAKARAN, Poway, CA (US)

(21) Appl. No.: 18/869,669

(22) PCT Filed: Jul. 14, 2022
(86) PCT No.: PCT/CN2022/105605

§ 371 Date: Nov. 26, 2024

(51) Int. Cl. H04B 7/06; H04W 72/044

(52) U.S. Cl. CPC H04B 7/0626; H04B 7/0639; H04W 72/044

(57) ABSTRACT

Various aspects of the present disclosure generally relate to wireless communication. In some aspects, a user equipment (UE) may receive, from a network node, an indication of an uplink resource associated with reporting channel state information (CSI). The UE may transmit, to the network node and using the uplink resource, uplink control information (UCI) including a CSI report that indicates precoding matrix indicator (PMI) values, based at least in part on prioritizing groups of information associated with the CSI report, at least one group, of the groups, being associated with time domain basis index values and non-zero coefficients of a coefficient matrix of a codebook associated with the CSI report. Numerous other aspects are provided.

### FIELD OF THE DISCLOSURE

Aspects of the present disclosure generally relate to wireless communication and specifically, to techniques and apparatuses associated with uplink control information (UCI) packing and prioritization for channel state information (CSI).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different UEs to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

A user equipment (UE) may report channel state information (CSI) feedback associated with a channel between the UE and a network node. For example, one feature of 5G systems is the use of multi-input multi-output (MIMO) transmission schemes to achieve high system throughput compared to previous generations of mobile systems. MIMO transmission generally requires the availability of accurate CSI used at a network node for a signal precoding using a precoding matrix of the data and control information. A comprehensive framework for CSI reporting may be defined, such as by a wireless communication standard, such as the 3GPP. The CSI is acquired in a first step at the UE based on the UE receiving CSI reference signals (CSI-RSs) from a network node. In a second step, the UE may determine a precoding matrix (for example, based on an estimated channel matrix) from a predefined set of matrices referred to as a “codebook.” The selected precoding matrix is reported by the UE (for example, in a CSI report) in a third step in the form of a precoding matrix indicator (PMI) and rank indicator (RI), among other examples.

In some examples, a UE may drop some parts of one or more CSI report(s) in an example where an uplink resource allocation (for example, a physical uplink shared channel (PUSCH) resource allocation) is not sufficient to carry the entire contents of the CSI report(s). Such scenarios may occur when a network node did not accurately allocate the PUSCH resources when scheduling the one or more CSI report(s). In such examples, the UE may drop a portion of uplink control information (UCI), such as information associated with the one or more CSI report(s) (which may be referred to as UCI omission). For example, the UE may transmit UCI via the uplink resource allocation. The UCI may include one or more CSI reports. UCI omission may be achieved by decomposing the UCI contents associated with the one or more CSI report(s) into groups of information associated with different priority levels. Each priority level may be associated with a group that is associated with a CSI report. The UE may drop information associated with one or more groups with lower priorities such that a total payload size of the UCI (for example, including the one or more CSI report(s)) fits within the uplink resource allocation (for example, the PUSCH resource allocation) for the UCI. For example, a UCI packing order (for example, indicating an order in which information is to be included in a given CSI report) or a UCI omission order (for example, indicating an order in which information associated with all CSI reports to be included in a UCI transmission is to be dropped) may be defined by the priority levels of respective groups associated with the one or more CSI report(s).

In some examples, a UE may move at medium or high velocities. In such examples, channel conditions associated with the UE may vary rapidly over time (for example, because the UE is moving at medium or high velocities). As such, a precoding matrix associated with the channel and the UE may vary rapidly over time. To handle the changing precoding matrix, a time domain basis codebook may be used by the UE for reporting CSI (for example, for reporting a PMI). For example, in additional to frequency domain bases and spatial domain bases, the precoding matrix associated with CSI report(s) may be associated with time domain bases.

The introduction of the time domain basis codebook (or a Doppler domain basis codebook) may provide beneficial CSI information (for example, a PMI) in medium or high velocity scenarios. For example, because a UE may include time domain bases and coefficients (for example, non-zero coefficients of a coefficient matrix of the time domain basis codebook) in a CSI report transmitted to a network node, the network node may be enabled to predict CSI or a precoding matrix for one or more future slots based on extrapolated time domain bases and coefficients indicated by the UE. This may improve communication performance in medium or high velocity scenarios where channel conditions associated with the UE may change rapidly. In some examples, the UE may perform UCI omission, as described above, in accordance with the UCI packing order or the UCI omission order (for example, that are defined by priority levels of respective groups associated with CSI report(s), as described above). However, the UCI packing order or the UCI omission order may not account for time domain bases and coefficients that are included in the CSI report. Because rules which are associated with defining a UCI packing order or a UCI omission order do not include information associated with time domain bases and coefficients, the UE and the network may not be synchronized as to what information is to be included in UCI when a size of an uplink resource is insufficient for CSI report(s) to be included in the UCI. As a result, the UE may omit critical or significant information in the UCI that is expected or needed by the network node. This may result in degraded CSI estimations by the network node and degraded communication performance for the UE because the network node may not receive the critical or significant information in the UCI.

### SUMMARY

Some aspects described herein relate to a user equipment (UE) for wireless communication. The UE may include at least one memory and at least one processor, communicatively coupled with the at least one memory. The at least one processor may be configured to cause the UE to receive, from a network node, an indication of an uplink resource associated with reporting channel state information (CSI). The at least one processor may be configured to cause the UE to transmit, to the network node and using the uplink resource, uplink control information (UCI) including a CSI report that indicates precoding matrix indicator (PMI) values, based at least in part on prioritizing groups of information associated with the CSI report, at least one group, of the groups, being associated with time domain basis index values and non-zero coefficients of a coefficient matrix of a codebook associated with the CSI report.

Some aspects described herein relate to a network node for wireless communication. The network node may include at least one memory and at least one processor, communicatively coupled with the at least one memory. The at least one processor may be configured to cause the network node to transmit an indication of an uplink resource, intended for a UE, associated with reporting CSI. The at least one processor may be configured to cause the network node to receive UCI associated with the UE and the uplink resource, the UCI being associated with groups for prioritization of information associated with the CSI report, at least one group, of the groups, being associated with time domain basis index values and non-zero coefficients of a coefficient matrix of a codebook associated with the CSI report.

Some aspects described herein relate to a method of wireless communication performed by a UE. The method may include receiving, from a network node, an indication of an uplink resource associated with reporting CSI. The method may include transmitting, to the network node and using the uplink resource, UCI including a CSI report that indicates PMI values, based at least in part on prioritizing groups of information associated with the CSI report, at least one group, of the groups, being associated with time domain basis index values and non-zero coefficients of a coefficient matrix of a codebook associated with the CSI report.

Some aspects described herein relate to a method of wireless communication performed by a network node. The method may include transmitting an indication of an uplink resource, intended for a UE, associated with reporting CSI. The method may include receiving UCI associated with the UE and the uplink resource, the UCI including a CSI report that indicates PMI values, the UCI being associated with groups for prioritization of information associated with the CSI report, at least one group, of the groups, being associated with time domain basis index values and non-zero coefficients of a coefficient matrix of a codebook associated with the CSI report.

Some aspects described herein relate to a non-transitory computer-readable medium that stores a set of instructions for wireless communication by a UE. The set of instructions, when executed by one or more processors of the UE, may cause the UE to receive, from a network node, an indication of an uplink resource associated with reporting CSI. The set of instructions, when executed by one or more processors of the UE, may cause the UE to transmit, to the network node and using the uplink resource, UCI including a CSI report that indicates PMI values, based at least in part on prioritizing groups of information associated with the CSI report, at least one group, of the groups, being associated with time domain basis index values and non-zero coefficients of a coefficient matrix of a codebook associated with the CSI report.

Some aspects described herein relate to a non-transitory computer-readable medium that stores a set of instructions for wireless communication by a network node. The set of instructions, when executed by one or more processors of the network node, may cause the network node to transmit an indication of an uplink resource, intended for a UE, associated with reporting CSI. The set of instructions, when executed by one or more processors of the network node, may cause the network node to receive UCI associated with the UE and the uplink resource, the UCI being associated with groups for prioritization of information associated with the CSI report, at least one group, of the groups, being associated with time domain basis index values and non-zero coefficients of a coefficient matrix of a codebook associated with the CSI report.

Some aspects described herein relate to an apparatus for wireless communication. The apparatus may include means for receiving, from a network node, an indication of an uplink resource associated with reporting CSI. The apparatus may include means for transmitting, to the network node and using the uplink resource, UCI including a CSI report that indicates PMI values, based at least in part on prioritizing groups of information associated with the CSI report, at least one group, of the groups, being associated with time domain basis index values and non-zero coefficients of a coefficient matrix of a codebook associated with the CSI report.

Some aspects described herein relate to an apparatus for wireless communication. The apparatus may include means for transmitting an indication of an uplink resource, intended for a UE, associated with reporting CSI. The apparatus may include means for receiving UCI associated with the UE and the uplink resource, the UCI including a CSI report that indicates PMI values, the UCI being associated with groups for prioritization of information associated with the CSI report, at least one group, of the groups, being associated with time domain basis index values and non-zero coefficients of a coefficient matrix of a codebook associated with the CSI report.

Aspects generally include a method, apparatus, system, computer program product, non-transitory computer-readable medium, user equipment, base station, network node, network entity, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example network node in communication with a user equipment (UE) in a wireless network, in accordance with the present disclosure.

FIG. 3 is a diagram illustrating an example disaggregated base station, architecture in accordance with the present disclosure.

FIG. 4 is a diagram illustrating an example of physical channels and reference signals in a wireless network, in accordance with the present disclosure.

FIG. 5 is a diagram illustrating an example of an enhanced Type II (eType-II) precoding matrix, in accordance with the present disclosure.

FIG. 6 is a diagram illustrating an example of uplink control information (UCI) packing and prioritization, in accordance with the present disclosure.

FIG. 7 is a diagram illustrating an example of prioritization of coefficients for a coefficient matrix, in accordance with the present disclosure.

FIG. 8 is a diagram of an example associated with UCI packing and prioritization for channel state information (CSI), in accordance with the present disclosure.

FIG. 9 is a diagram of an example associated with UCI packing orders and omission order for CSI, in accordance with the present disclosure.

FIGS. 10-13 are diagrams of examples associated with coefficient prioritization for a coefficient matrix associated with a PMI, in accordance with the present disclosure.

FIG. 14 is a flowchart illustrating an example process performed, for example, by a UE, associated with UCI packing and prioritization for CSI, in accordance with the present disclosure.

FIG. 15 is a flowchart illustrating an example process performed, for example, by a network node, associated with UCI packing and prioritization for CSI, in accordance with the present disclosure.

FIG. 16 is a diagram of an example apparatus for wireless communication in accordance with the present disclosure.

FIG. 17 is a diagram of an example apparatus for wireless communication in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate generally to uplink control information (UCI) packing and prioritization for channel state information (CSI). Some aspects more specifically relate to UCI packing and prioritization for CSI associated with time domain basis index values and coefficients for a precoding matrix indicator (PMI). For example, a user equipment (UE) may receive, from a network node, an indication of an uplink resource associated with reporting CSI (for example, for reporting a PMI). The UE may transmit, to the network node, UCI including a CSI report that indicates PMI information (for example, spatial domain bases, frequency domain bases, time domain bases, and one or more non-zero coefficients of a coefficient matrix, among other examples). The UE may include information in the UCI in accordance with a UCI packing order or a UCI omission order that is defined by respective priority levels of one or more groups of PMI information. In some aspects, at least one group, of the one or more groups, may be associated with time domain basis index values (for example, of the time domain bases included in the PMI information) and non-zero coefficients, from the coefficient matrix, that are associated with the time domain basis index values. A prioritization, UCI packing order, or UCI omission order for the UCI may be defined based at least in part on priority levels associated with respective groups of the one or more groups.

For example, the one or more groups include a first group that is associated with spatial domain beam index values and a strongest coefficient index (SCI). The one or more groups may further include a second group that is associated with frequency domain basis index values, the time domain basis index values, and a first portion of the non-zero coefficients of the coefficient matrix. The one or more groups may further include a third group that is associated with a second portion of the non-zero coefficients of the coefficient matrix. The UE may include information (for example, PMI information) in a CSI report in an order defined by the UCI packing order for the UCI. For example, the UCI packing order may be or indicate an order in which information associated with the first group is included in a CSI report first, followed by information associated with the second group, and further followed by information associated with the third group. In other words, the first group may have a highest priority level, followed by the second group, followed by the third group in terms of when information is packed in a CSI report.

In some aspects, a prioritization of the non-zero coefficients may include ordering the non-zero coefficients based at least in part on a permuted version of the coefficient matrix, where the permuted version includes at least one of a time domain permutation or a frequency domain permutation. For example, the prioritization of the non-zero coefficients may include ordering (for example, from highest priority to lowest priority) coefficients of the permuted version of the coefficient matrix of all frequency domain indices and spatial domain indices for each respective time domain index of the permuted version of the coefficient matrix. As another example, the prioritization of the non-zero coefficients may include ordering coefficients of the permuted version of the coefficient matrix of all time domain indices and spatial domain indices for each respective frequency domain index of the permuted version of the coefficient matrix.

Particular aspects of the subject matter described in this disclosure can be implemented to realize one or more of the following potential advantages. In some examples, the described techniques can be used to synchronize the UCI packing order and the UCI omission order between a UE and a network node when time domain bases and coefficients are reported by a UE in a CSI report (for example, in UCI). Additionally, this may enable the UE to ensure that more critical or significant information (for example, from time domain bases and coefficients, frequency domain bases and coefficients, and spatial domain bases and coefficients) is included in the UCI in scenarios where an uplink resource to be used to transmit the UCI is insufficient to carry all information associated with the UCI. Further, this may enable the UE to include time domain bases and coefficients in CSI reports. The UE including the time domain bases and coefficients in CSI reports may improve CSI estimations (for example, performed by a network node) in medium or high velocity scenarios (for example, where CSI of a channel may be changing rapidly over time), thereby improving communication performance for the UE.

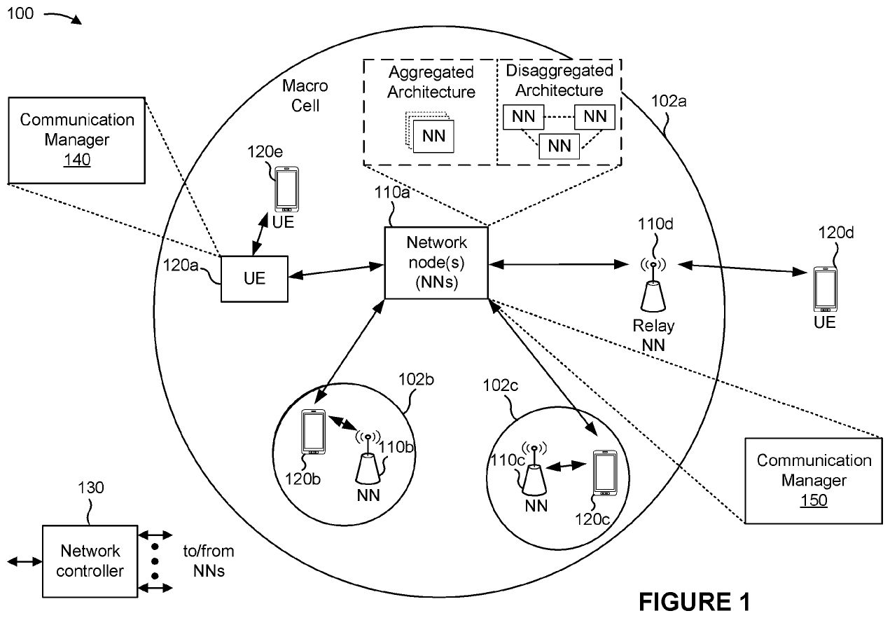

FIG. 1 is a diagram illustrating an example of a wireless network in accordance with the present disclosure. The wireless network 100 may be or may include elements of a 5G (for example, NR) network or a 4G (for example, Long Term Evolution (LTE)) network, among other examples. The wireless network 100 may include one or more network nodes 110 (shown as a network node (NN) 110a, a network node 110b, a network node 110c, and a network node 110d), a user equipment (UE) 120 or multiple UEs 120 (shown as a UE 120a, a UE 120b, a UE 120c, a UE 120d, and a UE 120e), or other network entities. A network node 110 is an entity that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, or one or more DUs. A network node 110 may include, for example, an NR network node, an LTE network node, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, or backhaul interfaces, such as a direct physical connection, an air interface, or a virtual network, using any suitable transport network.

Each network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used.

A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts). In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

A network controller 130 may couple to or communicate with a set of network nodes 110 and may provide coordination and control for these network nodes 110. The network controller 130 may communicate with the network nodes 110 via a backhaul communication link. The network nodes 110 may communicate with one another directly or indirectly via a wireless or wireline backhaul communication link. In some aspects, the network controller 130 may be a CU or a core network device, or the network controller 130 may include a CU or a core network device.

In some examples, a cell may not necessarily be stationary, and the geographic area of the cell may move in accordance with the location of a network node 110 that is mobile (for example, a mobile network node). In some examples, the network nodes 110 may be interconnected to one another or to one or more other network nodes 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (for example, a network node 110 or a UE 120) and send a transmission of the data to a downstream station (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay network node, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any quantity of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

In some aspects, actions described herein as being performed by a network node 110 may be performed by multiple different network nodes. For example, configuration actions may be performed by a first network node (for example, a CU or a DU), and radio communication actions may be performed by a second network node (for example, a DU or an RU).

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). Although a portion of FR1 is greater than 6 GHZ, FR1 is often referred to (interchangeably) as a “Sub-6 GHz” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHZ-300 GHz). Each of these higher frequency bands falls within the EHF band.

With the above examples in mind, unless specifically stated otherwise, the term “sub-6 GHZ,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive, from a network node, an indication of an uplink resource associated with reporting CSI; and transmit, to the network node and using the uplink resource, UCI including a CSI report that indicates PMI values, based at least in part on prioritizing groups of information associated with the CSI report, at least one group, of the groups, being associated with time domain basis index values and non-zero coefficients of a coefficient matrix of a codebook associated with the CSI report. Additionally or alternatively, the communication manager 140 may perform one or more other operations described herein.

In some aspects, the network node 110 may include a communication manager 150. As described in more detail elsewhere herein, the communication manager 150 may transmit an indication of an uplink resource, intended for a UE, associated with reporting CSI; and receive UCI associated with the UE and the uplink resource, the UCI including a CSI report that indicates PMI values, the UCI being associated with groups for prioritization of information associated with the CSI report, at least one group, of the groups, being associated with time domain basis index values and non-zero coefficients of a coefficient matrix of a codebook associated with the CSI report. Additionally or alternatively, the communication manager 150 may perform one or more other operations described herein.

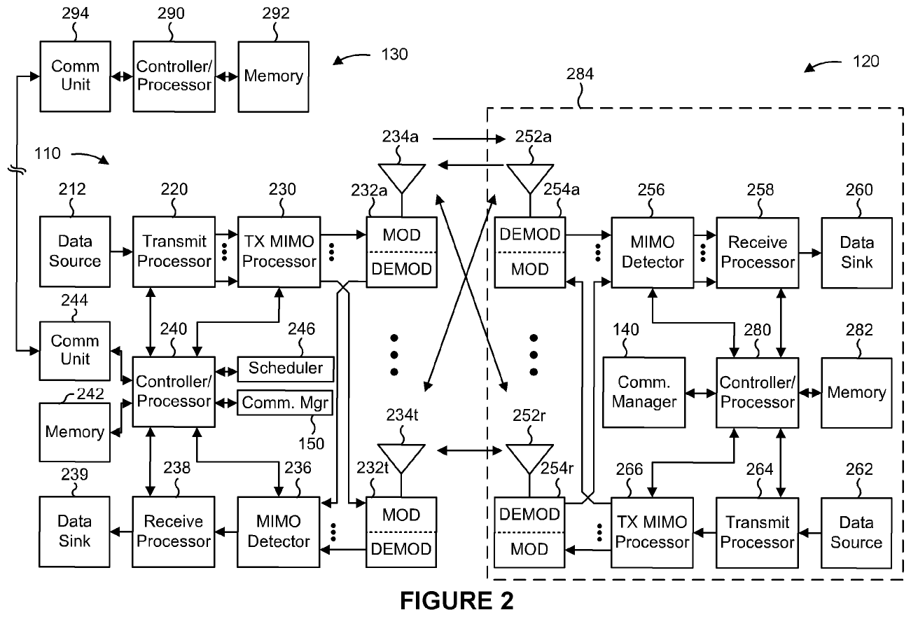

FIG. 2 is a diagram illustrating an example network node in communication with a UE in a wireless network in accordance with the present disclosure. The network node may correspond to the network node 110 of FIG. 1. Similarly, the UE may correspond to the UE 120 of FIG. 1. The network node 110 may be equipped with a set of antennas 234a through 234t, such as T antennas (T≥1). The UE 120 may be equipped with a set of antennas 252a through 252r, such as R antennas (R≥1). The network node 110 of depicted in FIG. 2 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (for example, encode and modulate) the data for the UE 120 based at least in part on the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a PSS or an SSS). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the methods described herein.

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the methods described herein.

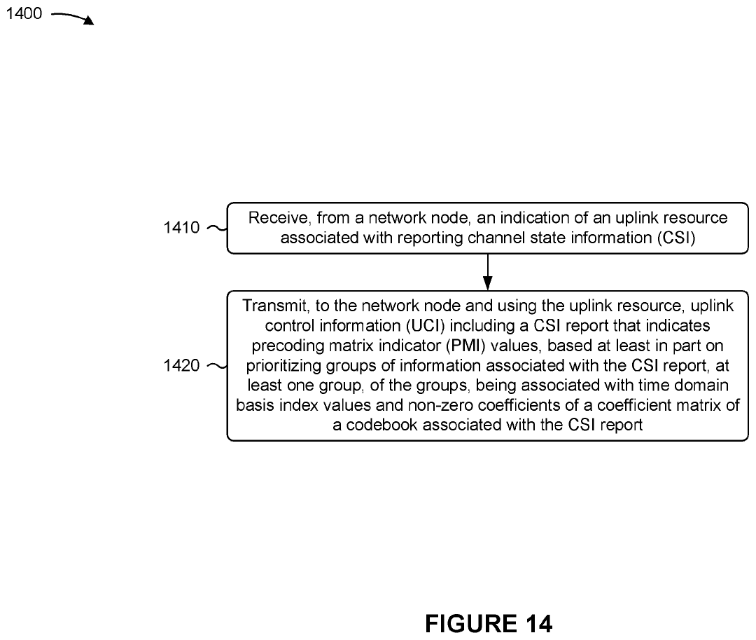

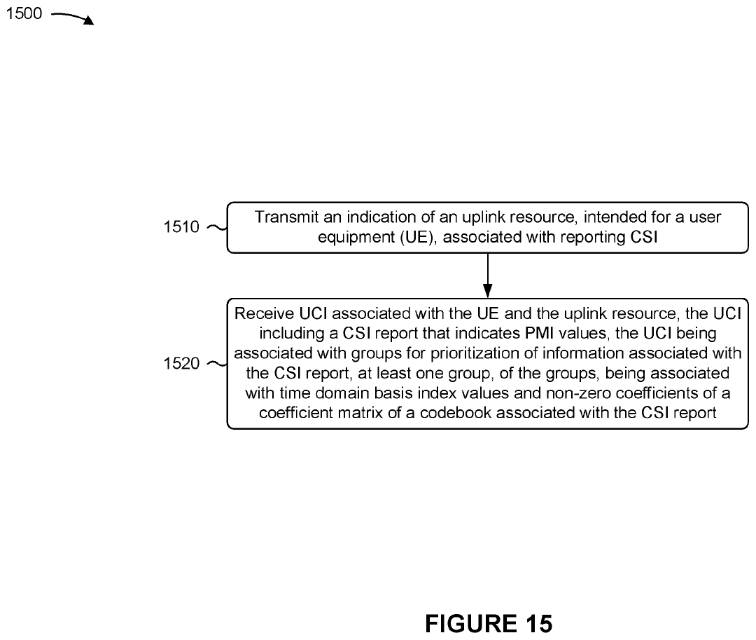

The controller/processor 240 of the network node 110, the controller/processor 280 of the UE 120, or any other component(s) of FIG. 2 may perform one or more techniques associated with UCI packing and prioritization for CSI, as described in more detail elsewhere herein. For example, the controller/processor 240 of the network node 110, the controller/processor 280 of the UE 120, or any other component(s) of FIG. 2 may perform or direct operations of, for example, process 1400 of FIG. 14, process 1500 of FIG. 15, or other processes as described herein. The memory 242 and the memory 282 may store data and program codes for the network node 110 and the UE 120, respectively. In some examples, the memory 242 or the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 1400 of FIG. 14, process 1500 of FIG. 15, or other processes as described herein. In some examples, executing instructions may include running the instructions, converting the instructions, compiling the instructions, or interpreting the instructions, among other examples.

In some aspects, the UE 120 includes means for receiving, from a network node, an indication of an uplink resource associated with reporting CSI; or means for transmitting, to the network node and using the uplink resource, UCI including a CSI report that indicates PMI values, based at least in part on prioritizing groups of information associated with the CSI report, at least one group, of the groups, being associated with time domain basis index values and non-zero coefficients of a coefficient matrix of a codebook associated with the CSI report. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting an indication of an uplink resource, intended for a UE, associated with CSI; or means for receiving UCI associated with the UE and the uplink resource, the UCI including a CSI report that indicates PMI values, the UCI being associated with groups for prioritization of information associated with the CSI report, at least one group, of the groups, being associated with time domain basis index values and non-zero coefficients of a coefficient matrix of a codebook associated with the CSI report. In some aspects, the means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (for example, an aggregated network node) may be configured to utilize a radio protocol stack that is physically or logically integrated within a single RAN node (for example, within a single device or unit). A disaggregated base station (for example, a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

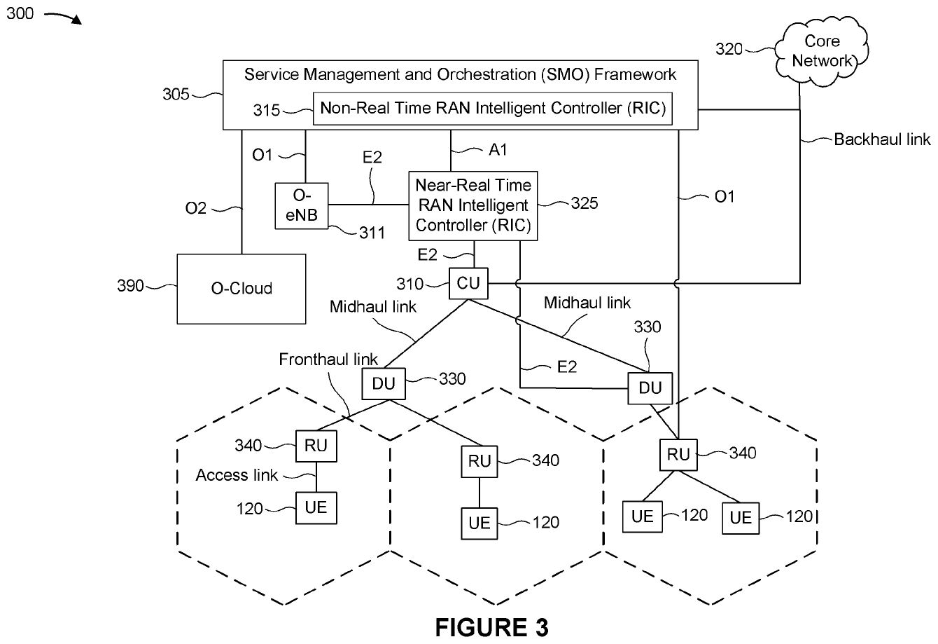

FIG. 3 is a diagram illustrating an example disaggregated base station architecture 300 in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

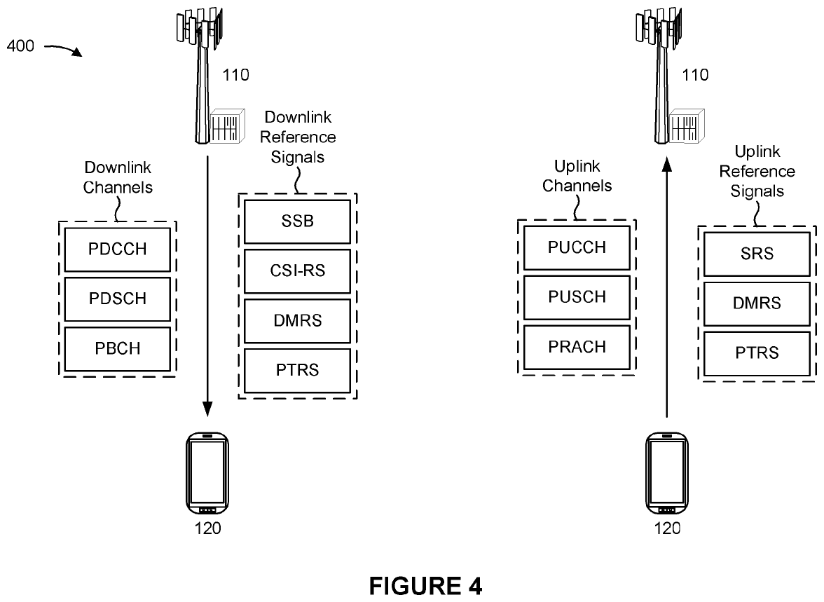

FIG. 4 is a diagram illustrating an example of physical channels and reference signals 400 in a wireless network, in accordance with the present disclosure. As shown in FIG. 4, downlink channels and downlink reference signals may carry information from a network node 110 to a UE 120, and uplink channels and uplink reference signals may carry information from a UE 120 to a network node 110.

As shown, a downlink channel may include a physical downlink control channel (PDCCH) that carries downlink control information (DCI), a physical downlink shared channel (PDSCH) that carries downlink data, or a physical broadcast channel (PBCH) that carries system information, among other examples. In some aspects, PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a PRACH used for initial network access, among other examples. In some aspects, the UE 120 may transmit acknowledgement (ACK) or negative acknowledgement (NACK) feedback (for example, ACK/NACK feedback or ACK/NACK information) in UCI on the PUCCH or the PUSCH.

As further shown, a downlink reference signal may include a synchronization signal block (SSB), a channel state information (CSI) reference signal (CSI-RS), a DMRS, a positioning reference signal (PRS), or a phase tracking reference signal (PTRS), among other examples. As also shown, an uplink reference signal may include a sounding reference signal (SRS), a DMRS, or a PTRS, among other examples.

An SSB may carry information used for initial network acquisition and synchronization, such as a primary synchronization signal (PSS), a secondary synchronization signal (SSS), a PBCH, and a PBCH DMRS. An SSB is sometimes referred to as a synchronization signal/PBCH (SS/PBCH) block. In some aspects, the network node 110 may transmit multiple SSBs on multiple corresponding beams, and the SSBs may be used for beam selection.

A CSI-RS may carry information used for downlink channel estimation (for example, downlink CSI acquisition), which may be used for scheduling, link adaptation, or beam management, among other examples. The network node 110 may configure a set of CSI-RSs for the UE 120, and the UE 120 may measure the configured set of CSI-RSs. Based at least in part on the measurements, the UE 120 may perform channel estimation and may report channel estimation parameters to the network node 110 (for example, in a CSI report), such as a CQI, a precoding matrix indicator (PMI), a CSI-RS resource indicator (CRI), a layer indicator (LI), a rank indicator (RI), or an RSRP, among other examples. The network node 110 may use the CSI report to select transmission parameters for downlink communications to the UE 120, such as a quantity of transmission layers (for example, a rank), a precoding matrix (for example, a precoder), an MCS, or a refined downlink beam (for example, using a beam refinement procedure or a beam management procedure), among other examples.

A DMRS may carry information used to estimate a radio channel for demodulation of an associated physical channel (for example, PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (for example, rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (for example, on the PDSCH) and uplink communications (for example, on the PUSCH).

A PRS may carry information used to enable timing or ranging measurements of the UE 120 based on signals transmitted by the network node 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (for example, a PDCCH). In general, a PRS may be designed to improve detectability by the UE 120, which may need to detect downlink signals from multiple neighboring network nodes in order to perform OTDOA-based positioning. Accordingly, the UE 120 may receive a PRS from multiple cells (for example, a reference cell and one or more neighbor cells), and may report a reference signal time difference (RSTD) based on OTDOA measurements associated with the PRSs received from the multiple cells. In some aspects, the network node 110 may then calculate a position of the UE 120 based on the RSTD measurements reported by the UE 120.

An SRS may carry information used for uplink channel estimation, which may be used for scheduling, link adaptation, precoder selection, or beam management, among other examples. The network node 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The network node 110 may measure the SRSs, may perform channel estimation based at least in part on the measurements, and may use the SRS measurements to configure communications with the UE 120.

A UE may determine CSI feedback associated with a channel between the UE and a network node. For example, one feature of 5G systems is the use of MIMO transmission schemes to achieve high system throughput compared to previous generations of mobile systems. MIMO transmission generally require the availability of accurate CSI used at a network node for a signal precoding using a precoding matrix of the data and control information. A comprehensive framework for CSI reporting may be defined, such as by a wireless communication standard, such as the 3GPP. The CSI is acquired in a first step at the UE based on received CSI-RS signals transmitted by a network node. In a second step, the UE may determine a precoding matrix (for example, based on an estimated channel matrix) from a predefined set of matrices referred to as a “codebook.” The selected precoding matrix is reported by the UE (for example, in a CSI report) in a third step in the form of a PMI and RI, among other examples.

The CSI feedback may be included in a CSI report transmitted by the UE to the network node. The CSI feedback may support a plurality of antenna configurations. The CSI feedback may be based at least in part on a dual stage codebook when the UE is configured with four or more antenna ports. One example of the dual stage codebook may be a PMI codebook. A PMI codebook may be associated with a precoder structure, which may be defined by W=W₁W₂. In other words, the precoder structure (W) may be a product of W₁ and W₂, where W₁ may represent long-term or wideband properties of the channel, and W₂ may represent short-term or sub-band (for example, a sub-band including a set of resource blocks) properties of the channel. The W₁ may be defined according to

$${W}_{1} = [ \begin{matrix}B & 0 \\ 0 & B\end{matrix} ] ,$$

where B may correspond to L oversampled two-dimensional discrete Fourier transform (DFT) beams, where Z is a positive integer.

A CSI feedback timeline may involve a UE selecting a set of beams given the precoding structure of the PMI codebook. A search complexity of W₁ and W₂ for the beam selection may increase depending on a quantity of antenna ports and layers, and may result in increased power consumption at the UE. Further, an increased search complexity may delay a reporting time of the CSI feedback (for example, the network node may wait an increased period of time to receive the CSI feedback from the UE).

For example, the search complexity of a W₁ computation performed at the UE may be an O₁,O₂, N₁,N₂ beam search, where O₁ and O₂ indicate DFT oversampling values, and N₁ and N₂ are based at least in part on a quantity of antennas in a horizontal dimension and a vertical dimension. In the case of 32 antenna ports, the O₁, O₂, N₁,N₂ beam search may correspond to a 256 beam search, where O₁ and O₂ are equal to four.

The DFT vectors in the codebook are grouped into (q₁, q₂), 0≤q₁≤O₁−1, 0≤q₂≤O₂−1 subgroups, where each subgroup contains N₁ N₂ DFT vectors, and the parameters q₁ and q₂ are denoted as the rotation oversampling factors. The second component, which may be referred to as a second stage precoder or coefficient matrix, W₂, is used to combine the selected beam vectors. Assuming a rank, R, transmission and a dual-polarized antenna array at the gNB with configuration (N₁, N₂, 2), the precoder for the s-th subband and r-th transmission layer is given by: W^{r}(s)=W₁W₂^{r}(s)=W₁F_{A}Ŵ₂^{r}(s), where the precoding matrix W^{r}(s) may have 2N₁ N₂ rows corresponding to the quantity of antenna ports, and S columns for the reporting subbands or physical resource blocks (PRBs). The matrix W₁ may be the wideband first-stage precoder containing 2U spatial beams for both polarizations, which may be identical for all S subbands, and F_{A} may be a diagonal matrix containing 2U wideband amplitudes associated with the 2U spatial beams, and W₂^{r}(s) is a second-stage precoder containing 2U subband (subband amplitude and phase) complex frequency-domain combining-coefficients associated with the 2U spatial beams for the s-th subband. The second stage precoder, W₂ is calculated on a subband basis such that the quantity of columns of W₂=[W₂^{r}(0) . . . W₂^{r}(s) . . . . W₂^{r}(s−1)] depends on a quantity of configured subbands. A subband may refer to a group of adjacent PRBs.

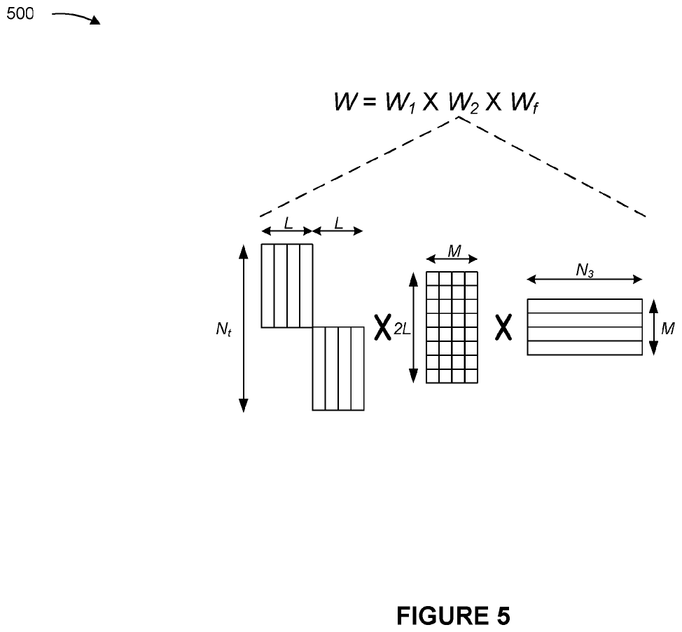

FIG. 5 is a diagram illustrating an example of an enhanced Type II (eType-II) precoding matrix 500, in accordance with the present disclosure. One drawback of the Type-II CSI feedback described above is a large feedback overhead for reporting the coefficients on a subband basis. The feedback overhead may increase (for example, approximately linearly) with the quantity of subbands. As a result, an overhead associated with CSI report may become large for large quantities of subbands. Therefore, an eType-II codebook has been defined (for example, by the 3GPP) to overcome the large feedback overhead associated with previous Type-II CSI feedback.

As shown in FIG. 5, the eType-II precoding matrix may be a three-stage precoder that relies on a three-stage codebook (for example, three components), W₁W₂^{r}W_{f}^{r}. The matrix W₁, may be similar to the matrix W₁ described above and may be independent of the layer (r). The matrix W₁ may contain a quantity of spatial domain (SD) basis vectors selected from a spatial codebook. The matrix W_{f}^{r} may be layer-dependent and may be used to select a quantity of frequency domain (or delay domain) basis vectors from a DFT-based matrix (which may be referred to as a delay codebook). The matrix W₂^{r} may be layer-dependent and may contain a quantity of combining coefficients that are used to combine the selected SD basis vectors and frequency domain basis vectors from the spatial and delay codebooks, respectively. As shown in FIG. 5, the matrix W₁ may contain Nₜ rows, where Nₜ is a quantity of spatial domain basis candidates or antenna ports, and 2L columns, where L is a quantity of selected CSI-RS ports per polarization (for example, a quantity of selected CSI-RS ports for a given transmission layer). The matrix W_{f} may have N₃ columns and M rows, where N₃ is a quantity of configured orthogonal DFT basis vectors or frequency domain candidates and M is a quantity of selected frequency domain basis vectors. A value of N₃ may be based at least in part on a quantity of CQI subbands and a quantity of PMI subbands, which may be RRC configured values. A value of M may be based on RRC configured parameters, such as RRC CSI codebook parameter Pᵥ. For example, a value of M may be

$${P}_{v} \times \frac{{N}_{3}}{R} ,$$

where R is a PMI subband size indicator (for example, which may be RRC configured). The matrix W₂ may have 2L rows and M columns, where M is a quantity of selected frequency domain basis vectors.

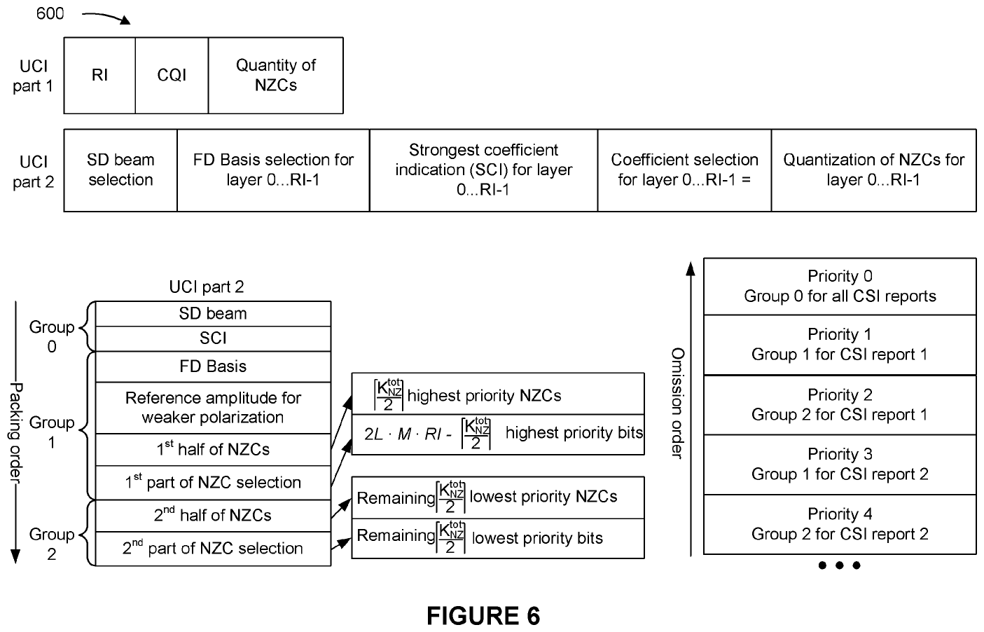

The matrix W₂ may be a linear combination coefficient matrix that includes 2L·M coefficients for linearly combining the selected M frequency domain basis vectors for the selected 2L CSI-RS ports. A UE may report (for example, in the CSI report) non-zero coefficients from the matrix W₂. For example, for a layer l, only a subset of Kₗ^{NZ} coefficients are non-zero and reported. The remaining (2L·M)−Kₗ^{NZ} coefficients are not reported by the UE (for example, in the CSI report) and are considered zero. In some examples, Kₗ^{NZ}≤K₀, where K₀ is a maximum quantity of non-zero coefficients for each layer, represented by K₀=[β×2LM], where β is an RRC configured parameter. The selected non-zero coefficients Kₗ^{NZ} for each layer, l, may be indicated via a bitmap (for example, having a size 2LM). For example, a value of “1” in the bitmap may indicate that a coefficient corresponding to the bit is non-zero, selected and reported by the UE. A value of “0” in the bitmap may indicate indicates that the coefficient corresponding to the bit is zero, and hence not reported by the UE. The bitmap may be included in the CSI report. For example, the bitmap may be included in a Part 2 of the CSI report, which may also be referred to as a UCI Part 2 (for example, as depicted and described in more detail in connection with FIG. 6).

A configuration (for example, an RRC configuration) associated with the CSI report may indicate a parameter indicating a quantity of spatial domain basis vectors to be selected by UE from the spatial codebook for the calculation of W₁, a parameter indicating a quantity of frequency domain (or delay domain) basis vectors to be selected by UE per layer from the delay codebook for the calculation of W_{f}, a value of K₀, or a value of N₃, among other examples. The UE may transmit a CSI report including an indication of a RI (for example, indicating a quantity of selected layers of the precoding matrix), a CQI, and a quantity of the non-zero coefficients selected by the UE. Additionally, the CSI report may include an indication of a PMI. The PMI may include indications of a spatial domain subset indicator (SD basis indicator) indicating the selected spatial domain basis vectors (i_{1,1}, i_{1,2}) (for example, the selected beams) for the RI layers of the precoding matrix, a frequency domain subset indicator indicating, for each layer (0 to RI−1), the selected frequency domain basis vectors (i_{1,5} and i_{1,6,l}), a strongest coefficient indicator (SCI) for each layer (0 to RI−1) indicating the SD basis index (or the SD and frequency domain basis indices) associated with the strongest coefficient (which is not reported) (i_{1,8,l}), a bitmap per layer indicating the SD basis indices and frequency domain basis indices associated with the non-zero coefficients for each layer (i_{1,7,l}), or a quantization of the selected non-zero coefficients (i_{2,3,l}, i_{2,4,l}, i_{2,5,l}), among other examples.

For example, one or more frequency domain vectors may be identified and indicated by means of the indices i_{1,5} (for N₃>19) and i_{1,6,l}. Amplitude coefficient indicators may be i_{2,3,l} and i_{2,4,l}. A phase coefficient indicator may be i_{2,5,l}. A bitmap whose nonzero bits identify which coefficients in i_{2,4,l} and i_{2,5,l} are reported, may be indicated by i_{1,7,l}.

FIG. 6 is a diagram illustrating an example 600 of UCI packing and prioritization, in accordance with the present disclosure. As shown in FIG. 6, a CSI report or UCI may include two parts, a Part 1 and a Part 2. CSI Part 1 and UCI part 1 may be used interchangeably herein. Similarly, CSI Part 2 and UCI Part 2 may be used interchangeably herein. Content included in the Part 1 and the Part 2 may be defined, or otherwise fixed, by a wireless communication standard, such as the 3GPP. For example, 3GPP Technical Specification 38.214 Version 17.2.0 Section 5.2.3 may define content included in CSI Part 1 and CSI Part 2 and prioritization of the content.

As shown in FIG. 6, the Part 1 may include an indication of an RI, a CQI and a quantity of non-zero coefficients (NZCs) associated with the PMI. The Part 2 may include the selected spatial domain basis vectors (i_{1,1}, i_{1,2}) (for example, the selected beams) for the RI layers of the precoding matrix, a frequency domain subset indicator indicating, for each layer (0 to RI−1), the selected frequency domain basis vectors (i_{1,5} and i_{1,6,l}), an SCI for each layer (0 to RI−1) indicating the SD basis index (or the SD and frequency domain basis indices) associated with the strongest coefficient (i_{1,8,l}), a bitmap for the coefficient selections for each layer indicating the SD basis indices and frequency domain basis indices associated with the non-zero coefficients for each layer (i_{1,7,l}), or a quantization of the selected non-zero coefficients (i_{2,3,l}, i_{2,4,l}, i_{2,5,l}), among other examples. The Part 1 may have a higher priority than the Part 2. For example, when determining content to be included in a CSI report, the content included in the UCI Part 1 may have a higher priority than the content included in the UCI Part 2.

UCI omission for PUSCH-based resource allocation and CSI reporting may be performed by the UE. In some examples, a UE to drop some parts of one or more CSI report(s) in an example where an uplink resource allocation (for example, a PUSCH resource allocation) is not sufficient to carry the entire content of the CSI report(s). UCI omission may occur when a network node did not accurately allocate the PUSCH resources when scheduling the CSI report(s). For example, the network node may allocate resources for a rank-1 (RI=1) CSI report, but the UE may determine a rank-2 transmission and reports a rank-2 (RI=2) CSI report of which size is larger than the size of the allocated PUSCH resources. In other words, the network (for example, one or more network nodes) may not know the RI value that will be selected by the UE when the network allocates the uplink resources for the CSI report(s). Therefore, in some cases, the allocated uplink resources may not be sufficient (for example, may not be large enough) to carry the entire content of the CSI report(s).

In such examples, the UE may drop a portion of the UCI (for example, which may be referred to as UCI omission). Dropping may be achieved by decomposing the UCI payload associated with the CSI reports into groups associated with different priority levels. Each priority level is associated with a group of information associated with a CSI report. The UE may drop the CSI groups with lower priority such that the payload size of the CSI reports fits with the uplink resource allocation (for example, the PUSCH resource allocation) for the CSI report(s). The size of UCI Part 1 may be fixed, whereas a size of the UCI Part 2 may vary depending on the selected RI by the UE and other factors. Because the network node may need information indicated by the UCI Part 1 in order to decode the UCI Part 2, UCI omission may be performed on the UCI Part 2 (for example, and not the UCI Part 1). In other words, information associated with the UCI Part 1 may not be dropped by the UE in such examples.

As shown in FIG. 6, the content associated with the UCI Part 2 may be divided into different groups. For example, a group 0 may include the selected spatial domain basis vectors (i_{1,1}, i_{1,2}) (for example, the selected beams) for the RI layers of the precoding matrix and the SCI for each layer (0 to RI−1) indicating the SD basis index (or the SD and frequency domain basis indices) associated with the strongest coefficient (i_{1,8,l}). A group 1 may include the selected frequency domain basis vectors (i_{1,5}, i_{1,6,l}), a reference amplitude for a weakest polarization associated with the selected non-zero coefficients (i_{2,3,l}), a quantization of a first half of the selected non-zero coefficients (i_{2,4,l}, i_{2,5,l}) (for example,

$$\frac{{K}_{T o t a l}^{N Z}}{2}$$

highest priority non-zero coefficients), and a bitmap indicating the spatial domain and frequency domain indices associated with the first half of the selected non-zero coefficients (i_{1,7,l}). A group 2 may include a quantization of a second half of the selected non-zero coefficients (i_{2,4,l}, i_{2,5,l}) (for example, a remaining

$$\frac{{K}_{T o t a l}^{N Z}}{2}$$

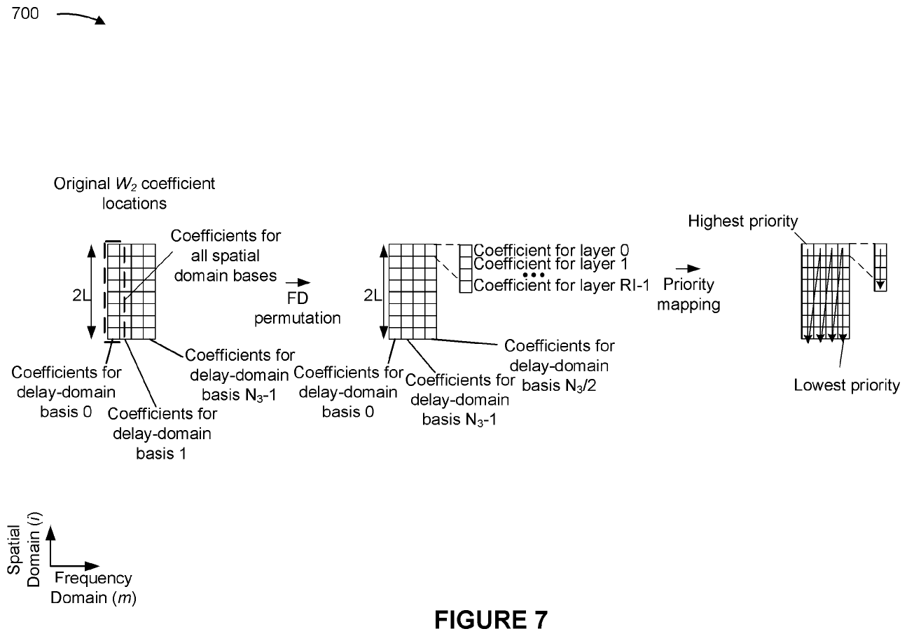

non-zero coefficients), and a bitmap indicating the spatial domain and frequency domain indices associated with the second half of the selected non-zero coefficients (i_{1,7,l}). As shown in FIG. 6, for a given CSI report, the group 0 may have a highest priority, followed by the group 1, followed by the group 2. In other words, when generating a CSI report, a UE may include information (for example, may pack the CSI report) associated with the group 0 first, followed by information associated with the group 1 (for example, if there is sufficient space in the uplink resource allocation), followed by information associated with the group 2 (for example, if there is sufficient space in the uplink resource allocation). The prioritization of the non-zero coefficients (for example, to facilitate the selection of the first half of the non-zero coefficients and the second half of the non-zero coefficients) is depicted and described in more detail in connection with FIG. 7.

The UCI omission may be associated with a UCI omission order. For example, as shown in FIG. 6, the UCI omission order may be based at least in part on an index value associated with CSI reports. For example, a CSI report 0 may have a higher priority than a CSI report 1, a CSI report 1 may have a higher priority than a CSI report 2, and so on. Additionally, the UCI omission order may be based at least in part on the groups of a given CSI report, as described above.

For example, assuming a PUSCH resource is associated with two CSI reports (for example, a CSI report 1 and a CSI report 2), the omission order for dropping or omitting information from the UCI carried via the PUSCH resource may follow the omission order depicted in FIG. 6. For example, the omission order may indicate that information associated with group 2 for CSI report 2 (or information associated with odd subbands for the CSI report 2) is to be omitted or dropped first. The omission order may indicate that information associated with group 1 for CSI report 2 (or information associated with even subbands for the CSI report 2) is to be omitted or dropped second. The omission order may indicate that information associated with group 2 for CSI report 1 (or information associated with odd subbands for the CSI report 1) is to be omitted or dropped third. The omission order may indicate that information associated with group 1 for CSI report 1 (or information associated with even subbands for the CSI report 1) is to be omitted or dropped fourth. The omission order may indicate that information associated with group 0 for all CSI reports is to be omitted or dropped fifth (or last). Following the omission order for UCI omission may enable the UE to include the more important information in a CSI report when the PUSCH resource allocated for the CSI report is insufficient to indicate all information associated with the CSI report.

FIG. 7 is a diagram illustrating an example 700 of prioritization of coefficients for a coefficient matrix, in accordance with the present disclosure. As described elsewhere herein, non-zero coefficients reported by a UE in a CSI report may be split into a first half and a second half for grouping associated with UCI omission procedures. For example, the coefficients may be prioritized. The first half of the non-zero coefficients may be associated with higher priorities than the second half of the non-zero coefficients.

For example, a coefficient cᵢ_{₁}ₘ_{₁}^{l}^{₁} (for example, associated with a layer index value l₁, a spatial domain basis index value i₁, and a frequency domain basis index value m₁) may have a lower priority than a coefficient cᵢ_{₂}ₘ_{₂}^{l}^{₂} (for example, associated with a layer index value l₂, a spatial domain basis index value i₂, and a frequency domain basis index value m₂) if prio(l₁, i₁, m₁)>prio(l₂, i₂, m₂) (for example, because a lower priority value is associated with a higher priority, such that a priority value 0 has a higher priority than a priority value 1), where prio(l, i, m) is a priority function. For example, the priority function may be defined as prio(l, i, m)=2L·RI·Perm(m)+RI·i+1, where Perm(m) maps the frequency domain basis indices following an order of frequency domain components, such as 0, N₃−1, 1, N₃−2, 2, N₃−3, 3, . . . and so on. Perm(m) may also be represented as π(f) (for example, in 3GPP Technical Specifications). For example, the Perm(m) may enable coefficients closer to the frequency domain basis index value 0 to be associated with a higher priority. This is because coefficients closer to the frequency domain basis index value 0 may have a higher likelihood of being significant in precoder or CSI determinations. The priority function may be interpreted as ordering the coefficients from highest priority to lowest priority following:

```
For m′ = Perm(m)
  For i = 0:2L-1
    For l = 0:RI-1
      Map c_{i,m′}^{l}
```

In other words, as shown in FIG. 7, the coefficient matrix W₂ may be associated with 2L spatial domain bases and N₃ delay domain (for example, frequency domain) bases. In order to prioritize the coefficients, the coefficient matrix W₂ may be permuted following an order or permutation indicated by Perm(m). For example, the frequency domain (FD) permutation may be associated a re-ordering of the columns of the coefficient matrix W₂ in accordance with Perm(m). The coefficients may be mapped to priority values based on the permuted coefficient matrix W₂. For example, as shown in FIG. 7, starting at a first column and a first row of the coefficient matrix W₂, a first coefficient may be mapped to a highest priority value (for example, “0”). The coefficients associated with the column (for example, associated with the frequency domain basis index value 0) may be mapped in descending order of priority. Following a mapping of a last spatial domain index value that is associated with the delay domain basis index value 0, a first spatial domain index value that is associated with a next frequency domain basis index value (for example, as indicated by the order of Perm(m)) map be mapped to a next priority value. For example, following mapping coefficients associated with the frequency domain basis index value 0 and all spatial domain basis index values, all spatial domain basis index values associated with the delay domain basis index value N₃−1 may be mapped (for example, because this is the next delay domain basis index value as indicated by the order of Perm(m)).

The remaining coefficients may be mapped in descending order of priority in a similar manner. Based at least in part on the prioritization of the coefficients, the UE may be enabled to identify the first half of the non-zero coefficients (for example, associated with group 1 of the UCI Part 2) and the second half of the non-zero coefficients (for example, associated with group 2 of the UCI Part 2).

In some examples, a UE may travel at high velocities. In such examples, channel conditions associated with the UE may vary rapidly over time (for example, because the UE is traveling at a high velocities). For example, a precoding matrix associated with the channel and the UE may vary rapidly over time. To handle the changing precoding matrix, a time domain basis codebook may be used by the UE for reporting CSI or a PMI. For example, the time domain basis codebook may be associated with time domain instances n, such that the precoding matrix may be represented as W(n)=W₁×W₂(n)×W_{f}. For example, the UE may extrapolate one or more non-zero coefficients for one or more coefficient matrices W₂(n) from one or more observed coefficient matrices W₂(n). The coefficient matrices may be compressed into the time domain. For example, in additional to frequency domain bases and spatial domain bases, the precoding matrix or CSI report may be associated with time domain bases. In one example, a time domain basis may be commonly selected for all spatial domain bases and frequency domain bases (for example, ((W_{f}*⊗W₁)W₂Wₜ^{H}, (W_{f}⊗W₁)W₂Wₜ^{H}, W₁W₂(Wₜ⊗W_{f})^{H} or W₁W₂(W_{f}⊗Wₜ)^{H}, where Wₜ is the time domain bases for the channel H). As another example, a time domain basis may be independently selected for different spatial domain bases and frequency domain bases.

As another example, the codebook may be a Doppler domain basis codebook. For example, the Doppler domain may be associated with, or correlate to, the time domain (whereas the delay domain may be associated with, or correlate to, the frequency domain). For example, a Doppler domain basis may be commonly selected for all spatial domain bases and frequency domain bases (for example, (W_{f}*⊗W₁)W₂W_{d}^{H}, (W_{f}⊗W₁)W₂W_{d}^{H}, W₁W₂(W_{d}⊗W_{f})^{H} or W₁W₂(W_{f}⊗W_{d})^{H}, where W_{d} is the Doppler domain bases for the channel). As another example, Doppler domain basis may be independently selected for different spatial domain bases and frequency domain bases. In some other examples, an eType-II codebook may be used for the medium or high velocity examples.

The introduction of the time domain basis codebook and the Doppler domain basis codebook may provide beneficial CSI or PMI information in medium or high velocity scenarios. For example, because a UE may include time domain bases and coefficients (for example, non-zero coefficients of a coefficient matrix of the time domain basis codebook) in a CSI report transmitted to a network node, the network node may be enabled to predict CSI or a precoding matrix for one or more future slots based on extrapolated time domain bases and coefficients indicated by the UE. This may improve communication performance in medium or high velocity scenarios where channel conditions associated with the UE may change rapidly. In some examples, the UE may perform UCI omission, as described above, in accordance with the UCI packing order or the UCI omission order (for example, that are defined by priority levels of respective groups associated with CSI report(s), as described above). However, the UCI packing order or the UCI omission order may not account for time domain bases and coefficients that are included in the CSI report. Because rules which are associated with defining a UCI packing order or a UCI omission order do not include information associated with time domain bases and coefficients, the UE and the network may not be synchronized as to what information is to be included in UCI when a size of an uplink resource is insufficient for CSI report(s) to be included in the UCI. As a result, the UE may omit critical or significant information in the UCI that is expected or needed by the network node. This may result in degraded CSI estimations by the network node and degraded communication performance for the UE because the network node may not receive the critical or significant information in the UCI.

Various aspects relate generally to UCI packing and prioritization for CSI. Some aspects more specifically relate to UCI packing and prioritization for CSI associated with time domain basis index values and coefficients for a PMI. For example, a UE may receive, from a network node, an indication of an uplink resource associated with reporting CSI (for example, for reporting a PMI). The UE may transmit, to the network node, UCI including a CSI report that indicates PMI information (for example, spatial domain bases, frequency domain bases, time domain bases, and one or more non-zero coefficients of a coefficient matrix, among other examples). The UCI may be associated with one or more groups of PMI information for a UCI packing order for the uplink resource. In some aspects, at least one group, of the one or more groups, may be associated with time domain basis index values (for example, of the time domain bases included in the PMI information) and non-zero coefficients, from the coefficient matrix, that are associated with the time domain basis index values. A prioritization, UCI packing order, or UCI omission order for the UCI may be defined based at least in part on priority levels associated with respective groups of the one or more groups.

For example, the one or more groups include a first group that is associated with spatial domain beam index values and a strongest coefficient index (SCI). The one or more groups may further include a second group that is associated with frequency domain basis index values, the time domain basis index values, and a first portion of the non-zero coefficients of the coefficient matrix. The one or more groups may further include a third group that is associated with a second portion of the non-zero coefficients of the coefficient matrix. The UE may include information (for example, PMI information) in a CSI report in an order defined by the UCI packing order for the UCI. For example, the UCI packing order may be or indicate an order in which information associated with the first group is included in a CSI report first, followed by information associated with the second group, and further followed by information associated with the third group. In other words, the first group may have a highest priority level, followed by the second group, followed by the third group in terms of when information is packed in a CSI report.

In some aspects, a prioritization of the non-zero coefficients may include ordering the non-zero coefficients based at least in part on a permuted version of the coefficient matrix, where the permuted version includes at least one of a time domain permutation or a frequency domain permutation. For example, the prioritization of the non-zero coefficients may include ordering (for example, from highest priority to lowest priority) coefficients of the permuted version of the coefficient matrix of all frequency domain indices and spatial domain indices for each respective time domain index of the permuted version of the coefficient matrix. As another example, the prioritization of the non-zero coefficients may include ordering coefficients of the permuted version of the coefficient matrix of all time domain indices and spatial domain indices for each respective frequency domain index of the permuted version of the coefficient matrix.

Particular aspects of the subject matter described in this disclosure can be implemented to realize one or more of the following potential advantages. In some examples, the described techniques can be used to synchronize the UCI packing order and the UCI omission order between a UE and a network node when time domain bases and coefficients are reported by a UE in a CSI report (for example, in UCI). Additionally, this may enable the UE to ensure that more critical or significant information (for example, from time domain bases and coefficients, frequency domain bases and coefficients, and spatial domain bases and coefficients) is included in the UCI in scenarios where an uplink resource to be used to transmit the UCI is insufficient to carry all information associated with the UCI. Further, this may enable the UE to include time domain bases and coefficients in CSI reports. The UE including the time domain bases and coefficients in CSI reports may improve CSI estimations (for example, performed by a network node) in medium or high velocity scenarios (for example, where CSI of a channel may be changing rapidly over time), thereby improving communication performance for the UE.

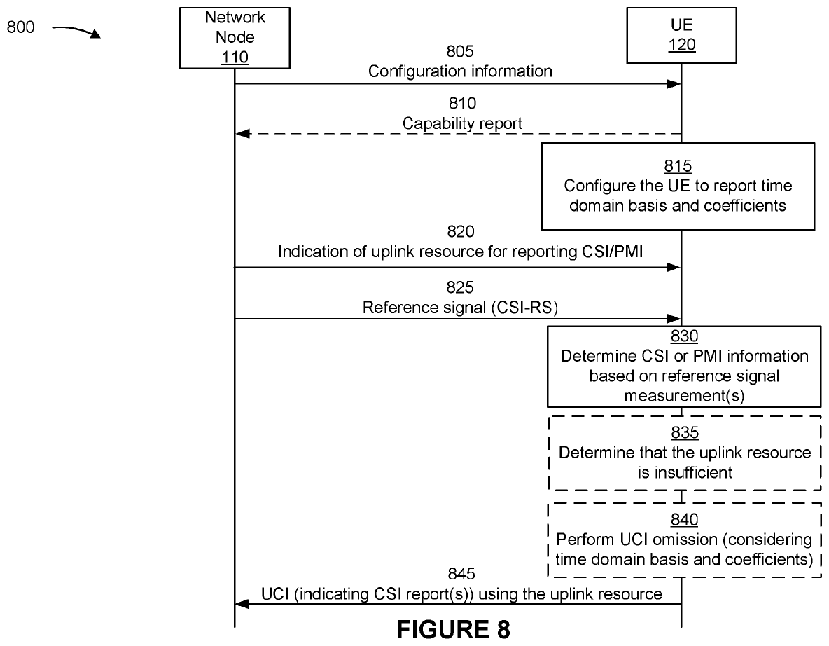

FIG. 8 is a diagram of an example associated with UCI packing and prioritization 800 for CSI, in accordance with the present disclosure. As shown in FIG. 8, one or more network nodes (for example, network node 110, a CU, a DU, or an RU) may communicate with a UE (for example, a UE 120). In some aspects, the network node 110 and the UE 120 may be part of a wireless network (for example, the wireless network 100). The UE 120 and the network node 110 may have established a wireless connection prior to operations shown in FIG. 8.

As used herein, the network node 110 “transmitting” a communication to the UE 120 may refer to a direct transmission (for example, from the network node 110 to the UE 120) or an indirect transmission via one or more other network nodes or devices. For example, if the network node 110 is a DU, an indirect transmission to the UE 120 may include the DU transmitting a communication to an RU and the RU transmitting the communication to the UE 120. Similarly, the UE 120 “transmitting” a communication to the network node 110 may refer to a direct transmission (for example, from the UE 120 to the network node 110) or an indirect transmission via one or more other network nodes or devices. For example, if the network node 110 is a DU, an indirect transmission to the network node 110 may include the UE 120 transmitting a communication to an RU and the RU transmitting the communication to the DU.

In a first operation 805, the network node 110 may transmit, and the UE 120 may receive, configuration information. In some aspects, the UE 120 may receive the configuration information via one or more of RRC signaling, one or more medium access control (MAC) control elements (MAC-CEs), or DCI, among other examples. In some aspects, the configuration information may include an indication of one or more configuration parameters (for example, stored by the UE 120 or previously indicated by the network node 110 or other network device) for selection by the UE 120, or explicit configuration information for the UE 120 to use to itself, among other examples.

In some aspects, the configuration information may be associated with a CSI configuration or a CSI-RS configuration. For example, the UE 120 may be configured with one or more non-zero power (NZP) CSI-RS resource set configurations as indicated by higher layer parameters CSI-ResourceConfig, and NZP-CSI-RS-ResourceSet. In some aspects, the configuration may be associated with a codebook configuration. For example, the UE 120 may be configured with a higher layer parameter codebookType. The codebook configuration may indicate a type of codebook to be used by the UE 120 for CSI reporting or PMI reporting. For example, the configuration may indicate that the codebook type is a time domain basis codebook or a Doppler domain basis codebook.

In some aspects, the configuration information may indicate values of one or more parameters associated with CSI reporting or PMI reporting. For example, the UE 120 may be configured with a higher layer parameter paramCombination indicating values for β, Pᵥ, or L, among other examples. As another example, the UE 120 may be configured with numberOfPMI-SubbandsPerCQI-Subband. As described elsewhere herein, this parameter may control a total quantity of precoding matrices N₃ indicated by the PMI as a function of the quantity of configured subbands in csi-ReportingBand, the subband size configured by the higher-level parameter subbandSize and of the total quantity of PRBs in the bandwidth part associated with the UE 120. In some aspects, the UE 120 may be configured with a quantity of time domain bases or Doppler domain bases, N₄, to be associated with the codebook (for example, via a higher layer parameter or an RRC parameter).

In some aspects, the configuration information may indicate that the UE 120 is to report CSI or a PMI for spatial domain basis index values, frequency domain basis index values, and time domain basis index values. For example, the configuration information may indicate that the UE 120 is configured with a codebook that is associated with time domain basis index values and coefficients. For example, the higher layer parameter codebookType may indicate that the UE 120 is configured with a time domain basis codebook in which a time domain basis is commonly selected for all spatial domain bases and frequency domain bases (for example, (W_{f}*⊗W₁)W₂Wₜ^{H}, (W_{f}⊗W₁)W₂Wₜ^{H}, W₁W₂ (Wₜ⊗W_{f})^{H} or W₁W₂ (W_{f}⊗Wₜ)^{H}, where Wₜ is the time domain bases for the channel) or a codebook associated with selected a time domain basis may be independently for different spatial domain bases and frequency domain bases. As another example, the configuration information may indicate that the codebook is a Doppler domain basis codebook. For example, the Doppler domain may be associated with, or correlate to, the time domain (whereas the delay domain may be associated with, or correlate to, the frequency domain). For example, the codebook may be associated with a commonly selected Doppler domain basis for all spatial domain bases and frequency domain bases (for example, (W_{f}*⊗W₁)W₂W_{d}^{H}, (W_{f}⊗W₁)W₂W_{d}^{H}, W₁W₂(W_{d}⊗W_{f})^{H} or W₁W₂(W_{f}⊗W_{d})^{H}, where W_{d} is the Doppler domain bases for the channel). As another example, Doppler domain basis may be independently selected for different spatial domain bases and frequency domain bases. In some other examples, the configuration information may indicate that an eType-II codebook that is associated with time domain bases is to be used by the UE 120.

In some aspects, the configuration information may indicate a part (for example, Part 1 or Part 2) of CSI or UCI that is associated with the time domain bases. In other aspects, the part (for example, Part 1 or Part 2) of CSI or UCI that is associated with the time domain bases may be defined, or otherwise fixed, by a wireless communication standard, such as the 3GPP (for example, and not indicated in the configuration information). In some aspects, the time domain bases may be included in the CSI (or UCI) Part 2 (for example, Part 2 as described in more detail elsewhere herein). For example, the UE 120 may be configured to select time domain basis for all layers (for example, from layer 0 to layer RI−1). The time domain basis selects for all layers may be associated with the CSI (or UCI) Part 2. Other content associated with CSI (or UCI) Part 1 and CSI (or UCI) Part 2 may be similar, or the same, as described elsewhere herein.

In some aspects, the configuration information may indicate a prioritization technique for coefficients of a coefficient matrix associated with the configured codebook. In other examples, the prioritization technique for coefficients of the coefficient matrix associated with the configured codebook may be defined, or otherwise fixed, by a wireless communication standard, such as the 3GPP. As described elsewhere herein, the prioritization of the coefficients may enable the UE 120 to select or identify a first portion (for example, a first half) of non-zero coefficients and a second portion (for example, a second half) of non-zero coefficients that are to be reported to the network node 110. The prioritization technique may be associated with prioritizing certain time domain basis indices (for example, in addition to spatial domain basis indices and frequency domain basis indices). For example, the prioritization technique may be associated with ordering the non-zero coefficients based at least in part on a permuted version of the coefficient matrix, where the permuted version include at least one of the time domain permutation and a frequency domain permutation. For example, the configuration information may indicate (or a wireless communication standard, such as the 3GPP, may define) a time domain permutation (for example, Perm_TD(s)) for time domain basis indices, s, of the coefficient matrix (W₂). The time domain permutation may indicate an order of the time domain basis indices in the permuted version of the coefficient matrix. In other words, the Perm_TD(s) may map the index s following an order of the corresponding time domain components. For example, the time domain permutation may be associated with an order of {0, N₄−1, 1, N₄−2, 2, N₄−3, 3, . . . , N₄/2}. As another example, the time domain permutation may be associated with a natural order, such as {0, 1, 2, 3, . . . , N₄−1} (for example, indicating that the time domain indices are not to be permuted). Additionally, the configuration information may indicate (or a wireless communication standard, such as the 3GPP, may define) a frequency domain permutation (for example, Perm_FD(m)) for frequency domain basis indices, m, of the coefficient matrix.

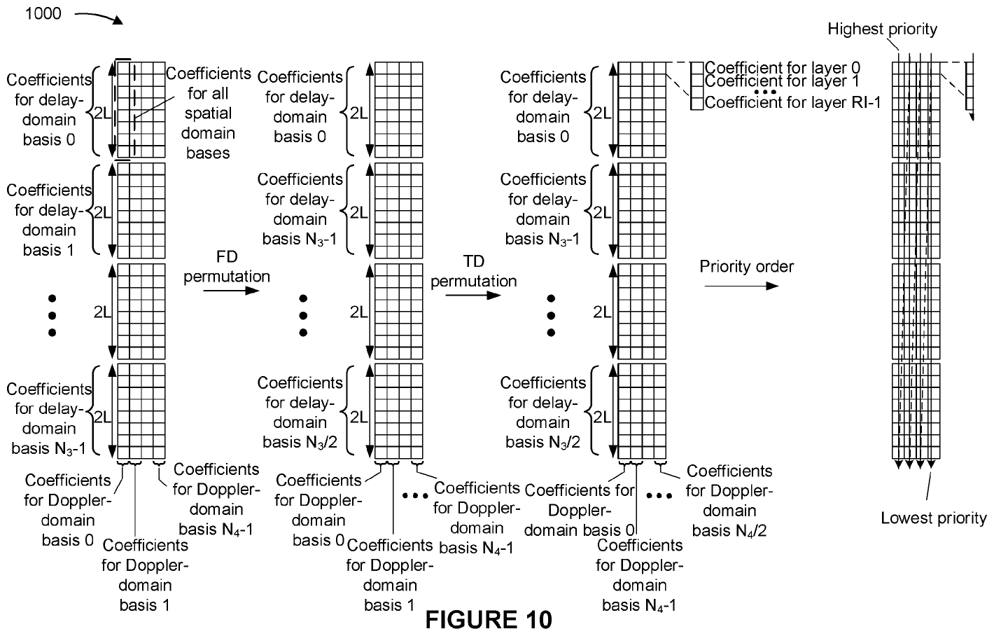

In some aspects, the prioritization technique may be associated with ordering the non-zero coefficients of the permuted version of the coefficient matrix by ordering frequency domain indices and spatial domain indices for each respective time domain index of the permuted version of the coefficient matrix (for example, where a resulting order of the coefficients indicates priority levels of the coefficients from highest priority to lowest priority). As another example, the prioritization technique may be associated ordering coefficients of the permuted version of the coefficient matrix by ordering time domain indices and spatial domain indices for each respective frequency domain index of the permuted version of the coefficient matrix. Examples of different prioritization techniques are depicted and described in more detail in connection with FIGS. 10-13.

In a second operation 810, the UE 120 may transmit, and the network node 110 may receive, a capability report. In some aspects, the capabilities report may indicate UE support for a time domain basis codebook or a Doppler domain basis codebook, as described above. For example, the UE 120 may indicate support for performing time domain basis selection for CSI or PMI reporting. In some aspects, the configuration information may be based at least in part on the capability report. For example, the UE 120 may be configured with a time domain basis codebook or a Doppler domain basis codebook for CSI reporting based at least in part on the capability report indicating that the UE 120 supports the time domain basis codebook or the Doppler domain basis codebook.

In a third operation 815, the UE 120 may configure itself based at least in part on the configuration information. In some aspects, the UE 120 may be configured to perform one or more operations described herein based at least in part on the configuration information.

In a fourth operation 820, the network node 110 may transmit, and the UE 120 may receive, an indication of an uplink resource associated with reporting CSI. For example, the uplink resource may be a PUSCH resource. For example, the UE 120 may perform aperiodic CSI reporting using the PUSCH on a serving cell associated with the network node 110 upon successful decoding of DCI (for example, DCI associated with a DCI format 0_1 or a DCI format 0_2, as defined, or otherwise fixed, by the 3GPP) which triggers an aperiodic CSI trigger state. The aperiodic CSI trigger state may be configured for the UE 120 via the configuration information. As another example, the UE 120 may perform semi-persistent CSI reporting on the PUSCH based at least in part on successfully decoding of DCI (for example, DCI associated with the DCI format 0_1 or the DCI format 0_2) which activates a semi-persistent CSI trigger state. The semi-persistent CSI trigger state(s) may be configured for the UE 120 via the configuration information. The DCI may contain a CSI request field which indicates the semi-persistent CSI trigger state to activate or deactivate.

As described elsewhere herein, for CSI feedback on the PUSCH, a CSI report may include of two parts. Part 1 may have a fixed payload size and may be used to identify the quantity of information bits in Part 2. The UE 120 may transmit Part 1 in its entirety before the LE 120 transmits Part 2. Part 1 may include an indication of RI (if reported), CQI, and an indication of the overall quantity of non-zero amplitude coefficients across layers. The fields of Part 1 (for example, RI (if reported), CQI, and the indication of the overall quantity of non-zero amplitude coefficients across layers) may be separately encoded (from Part 2) by the UE 120. Part 2 may include an indication of the PMI. For example, Part 2 may include time domain basis indices and coefficients. Additionally, Part 2 may include a spatial domain subset indicator (SD basis indicator) indicating the selected spatial domain basis vectors (i_{1,1}, i_{1,2}) (for example, the selected beams) for the RI layers of the precoding matrix, a frequency domain subset indicator indicating, for each layer (0 to RI−1), the selected frequency domain basis vectors (i_{1,5} and i_{1,6,l}), an SCI for each layer (0 to RI−1) indicating the SD basis index (or the SD and frequency domain basis indices) associated with the strongest coefficient (i_{1,8,l}), a bitmap per layer indicating the time domain basis indices, spatial domain basis indices, and frequency domain basis indices associated with the non-zero coefficients for each layer (i_{1,7,l}), or a quantization of the selected non-zero coefficients (i_{2,3,l}, i_{2,4,l}, i_{2,5,l}), among other examples.

In a fifth operation 825, the network node 110 may transmit, and the UE 120 may receive, a reference signal (for example, a downlink reference signal). For example, the reference signal may be a CSI-RS, among other examples. The CSI-RS may be an aperiodic CSI-RS, a semi-persistent CSI-RS, or a periodic CSI-RS. The UE 120 may measure the CSI-RS. In a sixth operation 830, the UE 120 may determine CSI or PMI information based at least in part on the reference signal measurement(s). For example, the UE 120 may perform measurements associated with various spatial domain basis candidates or frequency domain basis candidates as indicated by the codebook associated with the CSI reporting. The UE 120 may select spatial domain bases, frequency domain bases based at least in part on the measurement(s). Additionally, the UE 120 may select one or more time domain bases. For example, the UE 120 may observe (for example, measure) one or more time instances (for example, bases) of the PMI. The UE 120 may extrapolate one or more other time instances (for example, bases) of the PMI based at least in part on the one or more observed time instances.

In a sixth operation 835, the UE 120 may determine that the uplink resource (for example, indicated by the network node 110 in the fourth operation 820) is insufficient. As used herein, an uplink resource being “insufficient” may refer to the uplink resource not being large enough to carry all information associated with one or more CSI reports that are to be transmitted via the uplink resource. For example, uplink resource allocation (for example, the PUSCH resource allocation) may not be sufficient to carry the entire content of the CSI report(s). For example, UCI omission may occur when a network node did not accurately allocate the PUSCH resources when scheduling the CSI report(s). For example, the network node may allocate resources for a rank-1 (RI=1) CSI report, but the UE may determine determines a rank-2 transmission and reports a rank-2 (RI=2) CSI report of which size is larger than the size of the allocated PUSCH resources. In other words, the network (for example, one or more network nodes 110) may not know the RI value that will be selected by the UE 120 when the network allocates the uplink resources for the CSI report(s). Therefore, in some cases, the allocated uplink resources may not be sufficient (for example, may not be large enough) to carry the entire content of the CSI report(s). In such example, the UE 120 may omit some information from one or more CSI reports to enable the UE 120 to transmit other information via the insufficient uplink resource. When CSI reporting on PUSCH includes two parts, the UE 120 may omit a portion of the Part 2 CSI. Omission of Part 2 CSI is according to a priority order of one or more groups associated with the Part 2 CSI.

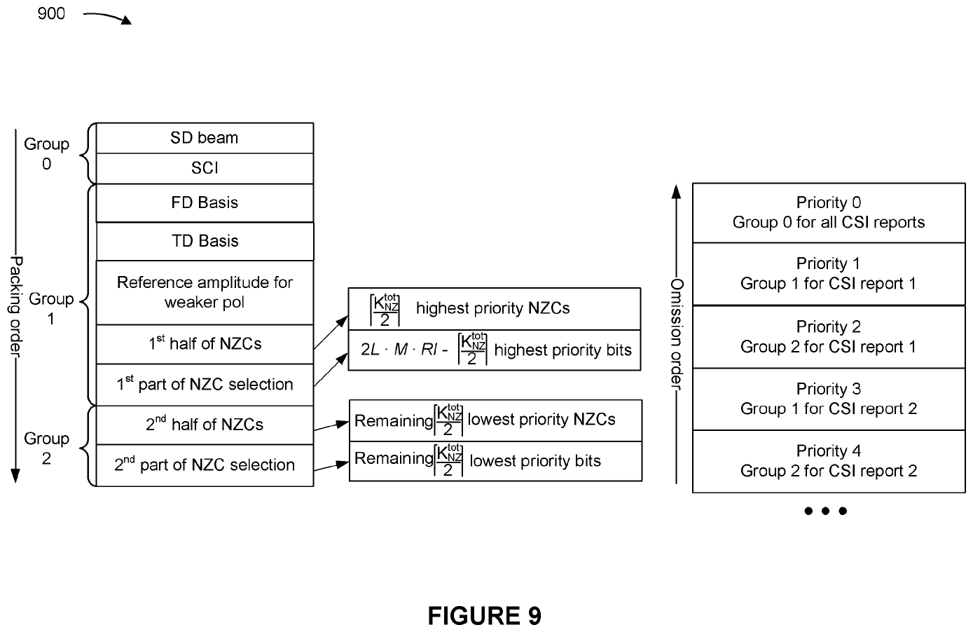

For example, the groups may be associated with respective priority levels. When omitting Part 2 CSI information for a particular priority level, the UE 120 may omit all of the information at that priority level. The groups of CSI Part 2 (or UCI Part 2) may include at least one group, of the one or more groups being associated with time domain basis index values and non-zero coefficients of a coefficient matrix. The groups are depicted and described in more detail in connection with FIG. 9. For example, the one or more groups may include a first group (for example, group 0) that is associated with spatial domain beam index values and strongest coefficient index values (for example, indices i_{1,1} (if reported), i_{1,2} (if reported) and (i_{1,8,l}). The one or more groups may include a second group (for example, group 1) that is associated with frequency domain basis index values, the time domain basis index values, and a first portion of the non-zero coefficients of the coefficient matrix, W₂, associated with the PMI values (for example, indices i_{1,5} (if reported), i_{1,6,l} (if reported), the first half of the highest priority elements of i_{1,7,l}, i_{2,3,l}, the highest priority elements of i_{2,4,l}, and the highest priority elements of i_{2,5,l}). The one or more groups may include a third group (for example, group 2) that is associated with a second portion (for example, a second half) of the non-zero coefficients of the coefficient matrix (for example, the second half of the lowest priority elements of (i_{1,7,l}, i_{2,4,l}, and i_{2,5,l}).

The first portion of the non-zero coefficients and the second portion of the non-zero coefficients may be selected based at least in part on a prioritization of the non-zero coefficients. In some aspects, the prioritization of the non-zero coefficients may be associated with a time domain permutation of the coefficient matrix. Examples of the prioritization of the non-zero coefficients with example codebooks are depicted and described in more detail in connection with FIGS. 10-13.

For example, the prioritization of the non-zero coefficients includes ordering the non-zero coefficients based at least in part on a permuted version of the coefficient matrix, where the permuted version include at least one of the time domain permutation and a frequency domain permutation. In some aspects, the time domain permutation may be associated with a Doppler domain. In some aspects, the frequency domain permutation may be associated with a delay domain. The division of non-zero coefficients into Group 1 and Group 2 may be based on the respective priorities of the non-zero coefficients. For example, a coefficient cᵢ_{₁}_{,m}_{₁}_{,s}_{₁}^{l}^{₁} (for example, associated with a layer index value l₁, a spatial domain basis index value i₁, a frequency domain basis index value m₁, and a time domain basis index value s₁) may have a lower priority than a coefficient cᵢ_{₂}_{,m}_{₂}_{,s}_{₂}^{l}^{₂} (for example, associated with a layer index value l₂, a spatial domain basis index value i₂, a frequency domain basis index value m₂, and a time domain basis index value s₂) if prio(l₁, i₁, m₁, s₁)>prio(l₂, i₂, m₂, s₂) (for example, because a lower priority value is associated with a higher priority, such that a priority value 0 has a higher priority than a priority value 1).

In one example, the prio(l, i, m, s) may be determined where the time domain is an outer level. For example, the priority function may be defined as prio(l, i, m)=RI·2L·M·Perm_TD(s)+RI·2L·Perm_FD(m)+RI·i+l, where Perm_FD(m) maps the frequency domain basis indices following an order of frequency domain components, such as 0, N₃−1, 1, N₃−2, 2, N₃−3, 3, . . . and so on. Perm_FD(m) may also be represented as π(f) (for example, in 3GPP Technical Specifications). Perm_FD(m) may be similar to, or the same as, the Perm(m) described elsewhere herein. Perm_TD(s) may map the index s following an order of the corresponding time domain components, as described in more detail elsewhere herein. Perm_TD(s) may also be represented as π(s) (for example, in 3GPP Technical Specifications). The priority function may be interpreted as ordering the coefficients from highest priority to lowest priority following:

```
For s′ = Perm_TD(s)
  For m′ = Perm_FD(m)
    For i = 0:2L-1
      For l = 0:RI-1
        Map c_{i,m′,s′}^{l}
```

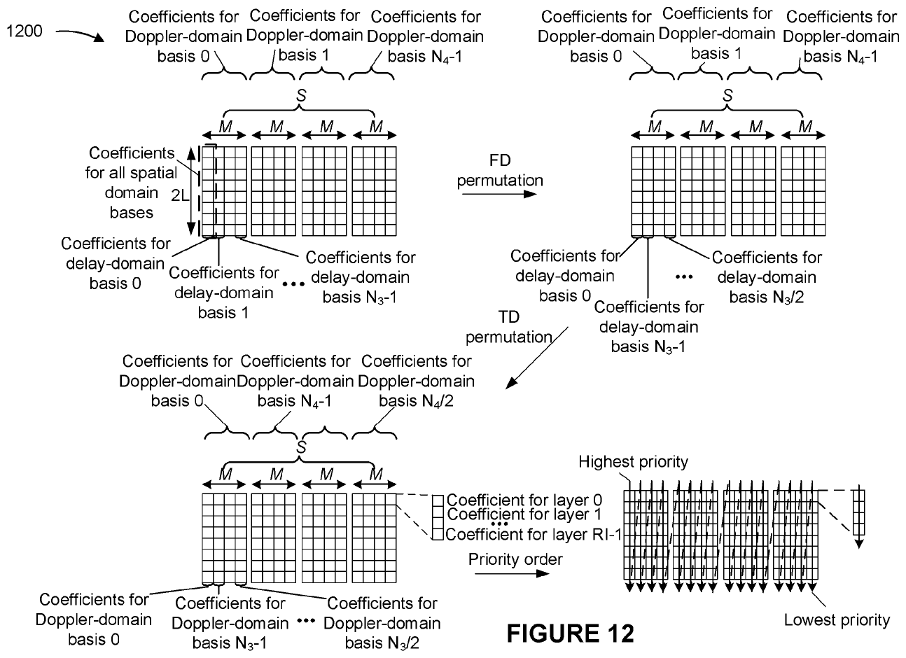

In other words, the ordering of the non-zero coefficients may include ordering coefficients of a permuted version of the coefficient matrix by ordering frequency domain indices and spatial domain indices for each respective time domain index of the permuted version of the coefficient matrix. Examples of the prio(l, i, m, s) where the time domain is an outer level are depicted and described in more detail in connection with FIGS. 10 and 12.

In some other aspects, the prio(l, i, m, s) may be determined where the frequency domain is an outer level. For example, the priority function may be defined as prio(l, i, m)=RI·2L·S·Perm_FD(m)+RI·2L·Perm_TD(s)+RI·i+1. The priority function may be interpreted as ordering the coefficients from highest priority to lowest priority following:

```
For m′ = Perm_FD(m)
  For s′ = Perm_TD(s)
    For i = 0:2L-1
      For l = 0:RI-1
        Map c_{i,m′,s′}^{l}
```

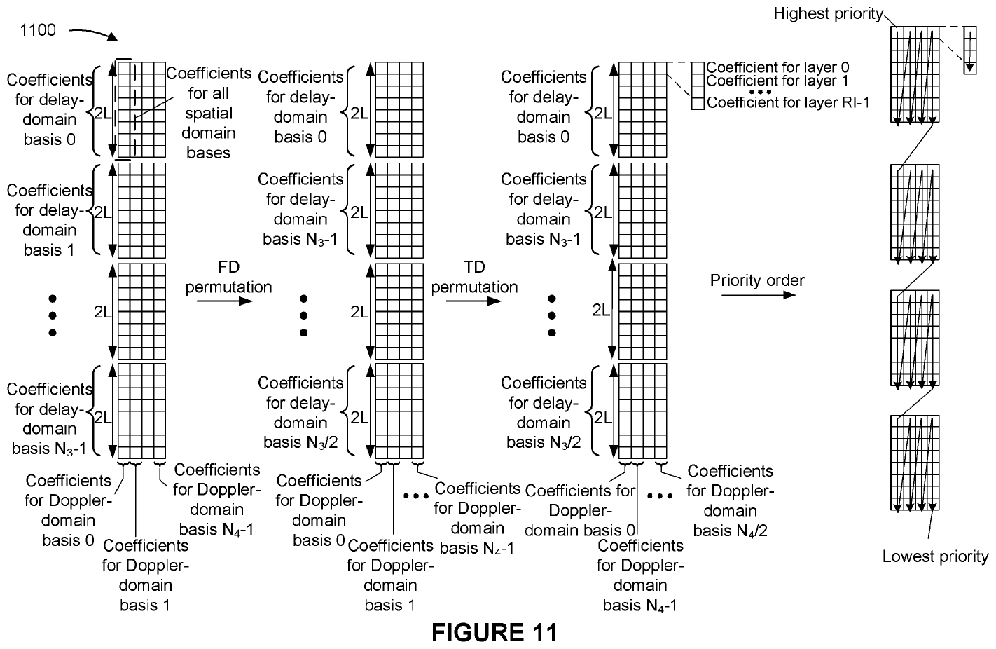

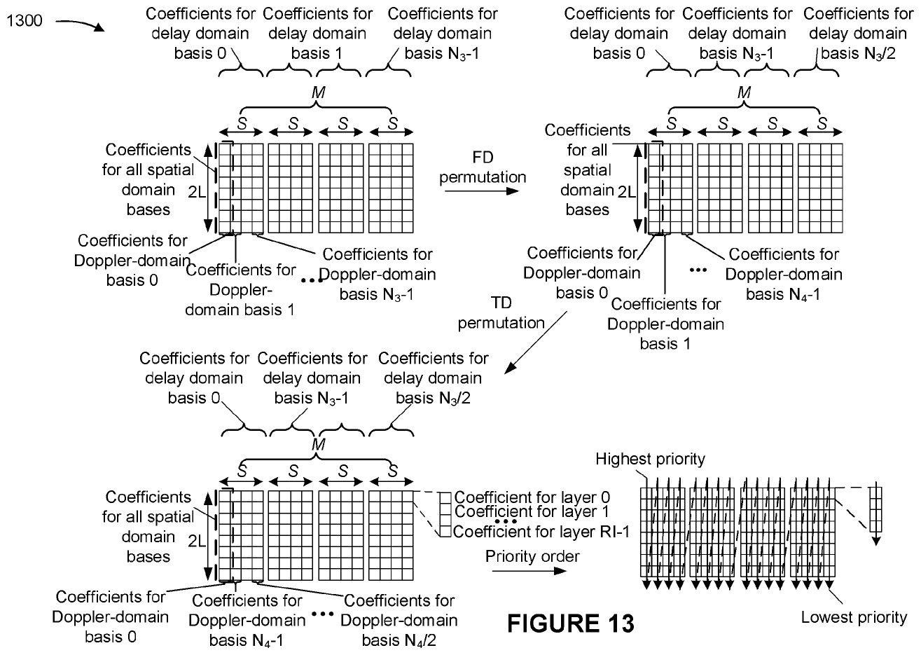

In other words, ordering of the non-zero coefficients may include ordering coefficients of a permuted version of the coefficient matrix by ordering time domain indices and spatial domain indices for each respective frequency domain index of the permuted version of the coefficient matrix. Examples of the prio(l, i, m, s) where the frequency domain is an outer level are depicted and described in more detail in connection with FIGS. 11 and 13.

In some aspects, in a seventh operation 840, the UE 120 may perform UCI omission (for example, considering time domain bases and coefficients). For example, the UE 120 may perform UCI omission (or CSI omission) based at least in part on the uplink resource to be used to transmit the UCI (or the CSI) being insufficient (for example, as determined in the sixth operation 835). For example, a size of the uplink resource may be insufficient for the CSI report. In such examples, the UE 120 may include information in an order (for example, a packing order) of first including information associated with the first group (for example, Group 0), second including information associated with the second group (for example, Group 1), and third (for example, last) including information associated with the third group (for example, Group 2). In other words, the UE 120 may omit information associated with at least one group from the one or more groups based at least in part on prioritizing the one or more groups (for example, based at least in part on prioritizing the first group over the second group and the third group and based at least in part on prioritizing the second group over the third group).

In some aspects, the uplink resource (for example, the PUSCH) resource may be associated with multiple CSI reports. In such examples, the UE 120 may omit information associated with one or more of the CSI reports based at least in part on prioritizing CSI reports, from the multiple CSI reports, in an order of index values of the multiple CSI reports. For example, in addition to prioritizing the groups of a given CSI report, the UE 120 may also prioritize multiple CSI reports based at least in part on the index values. For example, a CSI report 0 may have a higher priority than a CSI report 1, the CSI report 1 may have a higher priority than a CSI report 2, and so on.

In an eighth operation 845, the UE 120 may transmit, and the network node 110 may receive, UCI (for example, indicating information associated with one or more CSI reports) using the uplink resource (for example, that was indicated by the network node 110 in the fourth operation 820). For example, the UE 120 may transmit including a CSI report that indicates PMI values (for example, basis indices and non-zero coefficients). The UCI may be associated with one or more groups for packing prioritization for the uplink resource, as explained in more detail elsewhere herein. In some aspects, the UE 120 may refrain from transmitting some information associated with the CSI report based at least in part on performing UCI omission (for example, in the seventh operation 840). For example, the UE 120 may refrain from including one or more PMI values, from the PMI values, based at least in part on including information in an order in which information associated with the first group is included in the CSI report first, followed by information associated with the second group, and further followed by information associated with the third group. As another example, the UE 120 may refrain from including one or more PMI values, from the PMI values, based at least in part on omitting information associated with at least one group from the one or more groups based at least in part on prioritizing the one or more groups. As another example, where the uplink resource (for example, the PUSCH resource) is associated with multiple CSI reports, the UE 120 may refrain from including the one or more PMI values is based at least in part on prioritizing CSI reports, from the multiple CSI reports, in an order of index values of the multiple CSI reports.

The network node 110 may determine one or more communication parameters for the UE 120 based at least in part on the information included in the CSI report. For example, the network node 110 may determine a precoder based at least in part on the PMI included in the CSI report. The UE 120 and the network node 110 (for example, an RU) may communicate (for example, transmit or receive) communications using the one or more communication parameters determined by the network node 110 or another network node 110 (for example, a DU or a CU).

FIG. 9 is a diagram of an example associated with UCI packing orders and omission order 900 for CSI, in accordance with the present disclosure. As shown in FIG. 9, and as described elsewhere herein, a CSI report (or UCI) may be divided into groups having respective priority levels. For example, as shown in FIG. 9, the Group 0 may have a first priority level, the Group 1 may have a second priority level, and the Group 2 may have a third priority level. The first priority level may be a highest priority level, followed by the second priority level, followed by the third priority level.

For example, the packing order of UCI (or of a CSI report) may be associated with a descending priority level of the various groups. As shown in FIG. 9, the Group 0 may include the selected spatial domain basis vectors (i_{1,1}, i_{1,2}) (for example, the selected beams) for the RI layers of the precoding matrix and the SCI for each layer (0 to RI−1) indicating the SD basis index (or the SD and frequency domain basis indices) associated with the strongest coefficient (i_{1,8,l}). The Group 1 may include frequency domain basis index values, the selected time domain basis index values, a reference amplitude index value, and a first portion of the non-zero coefficients of the coefficient matrix, W₂, associated with the PMI values (for example, indices i_{1,5} (if reported), i_{1,6,l} (if reported), the first half of the highest priority elements of i_{1,7,l}, i_{2,3,l}, the highest priority elements of i_{2,4,l}, and the highest priority elements of i_{2,5,l}). The Group 2 may include a second portion (for example, a second half) of the non-zero coefficients of the coefficient matrix (for example, the second half of the lowest priority elements of i_{1,7,l}, i_{2,4,l}, and i_{2,5,l}). The first half of the NZCs and the second half of the NZCs may be determined based at least in part on prioritizing coefficients of the coefficient matrix, as described elsewhere herein.

The UCI omission may be associated with a UCI omission order. For example, as shown in FIG. 9, the omission order may be based at least in part on an index value associated with CSI reports. For example, a CSI report 0 may have a higher priority than a CSI report 1, a CSI report 1 may have a higher priority than a CSI report 2, and so on. Additionally, the UCI omission order may be based at least in part on the groups of a given CSI report, as described above.

For example, assuming a PUSCH resource is associated with two CSI reports (for example, a CSI report 1 and a CSI report 2), the omission order for dropping or omitting information from the UCI carried via the PUSCH resource may follow the omission order depicted in FIG. 9. For example, the omission order may indicate that information associated with Group 2 for CSI report 2 is to be omitted or dropped first. The omission order may indicate that information associated with Group 1 for CSI report 2 is to be omitted or dropped second. The omission order may indicate that information associated with Group 2 for CSI report 1 is to be omitted or dropped third. The omission order may indicate that information associated with Group 1 for CSI report 1 is to be omitted or dropped fourth. The omission order may indicate that information associated with Group 0 for all CSI reports is to be omitted or dropped fifth (or last). Following the omission order for UCI omission may enable the UE to include the more important information in a CSI report when the PUSCH resource allocated for the CSI report is insufficient to indicate all information associated with the CSI report.

FIG. 10 is a diagram of an example associated with coefficient prioritization 1000 for a coefficient matrix associated with a PMI, in accordance with the present disclosure. The coefficient matrix depicted in FIG. 10 may be associated with a time domain basis codebook or a Doppler domain basis codebook, as described in more detail elsewhere herein. For example, the codebook may be (W_{f}⊗W₁)W₂Wₜ^{H}, (W_{f}*⊗W₁)W₂Wₜ^{H}, (W_{f}⊗W₁)W₂W_{d}^{H} or (W_{f}*⊗W₁)W₂W_{d}^{H}, where the coefficient matrix W₂ is depicted in FIG. 10.

For example, the coefficient matrix may be associated with one or more sets of coefficients. Each set, from the one or more sets, may associated with a respective frequency domain basis index (for example, a delay domain basis as depicted in FIG. 10). For example, a first set or group of coefficients may be associated with the delay domain basis (m) 0, a second set of group of coefficients may be associated with the delay domain basis (m) 1, and so on (for example, for all delay domain basis index values 0 through N₃−1). Each set may include columns for time domain basis indices s (for example, Doppler domain basis indices as depicted in FIG. 10) associated with the coefficient matrix and rows for spatial domain basis indices, i, associated with the coefficient matrix. For example, as shown in FIG. 10, a given set or group of coefficients associated with a given delay domain basis index value may include coefficients for all Doppler domain index values (for example, 0 through N₄−1) and for all spatial domain index values (for example, 0 through 2L−1). Each block shown in FIG. 10 may be associated with multiple coefficients for respective layers (for example, coefficients for layers 0 through RI−1).

As shown in FIG. 10, the prioritization of the coefficients of the coefficient matrix may be associated with one or more permutations of the coefficient matrix. For example, an FD permutation (for example, Perm_FD(m)) may be performed. The frequency domain permutation may be associated with re-ordering the sets or groups of coefficients in an order indicated by the Perm_FD(m). For example, the order of the frequency domain permutation as depicted in FIG. 10 may be {0, N₃−1, 1, N₃−2, 2, . . . , N₃/2}. This order is provided as an example and other orders are also possible.

In some aspects, the prioritization of the coefficients of the coefficient matrix may be associated with a time domain (TD) permutation (for example, Perm_TD(s)). In other examples, the time domain permutation may not be performed. For example, the columns of the coefficient matrix may be re-ordered in accordance with an order indicated by the time domain permutation. For example, the columns of the coefficient matrix may be re-ordered to an order of {0, N₄−1, 1, N₄−2, 2, . . . , N₄/2}.

After permuting the coefficient matrix, the coefficients may be ordered in a priority order. For example, the coefficients may be ordered from a highest priority (for example, priority level 0) to a lowest priority. As shown in FIG. 10, the ordering of the coefficients may include ordering coefficients of the permuted version of the coefficient matrix by ordering coefficients for the rows for the spatial domain basis indices, and the one or more sets, associated with each respective column, of the columns for the time domain basis indices, in an order of the columns. In other words, starting at a first row and a first column (for example, associated with Doppler domain basis index value 0), the coefficients may be ordered descending down the column through each delay domain index value set. After a last coefficient associated with the column (for example, associated with Doppler domain basis index value 0) has been ordered or mapped to a priority level, a coefficient included in a first row and a next column (for example, associated with Doppler domain basis index value N₄−1) may be ordered or mapped to a priority level.

The priority mapping or ordered may continue in a similar manner until all coefficients have been mapped to a priority level. The UE 120 may identify the first half of the non-zero coefficients based at least in part on ordering all non-zero coefficients in the order associated with the priority mapping and taking the first half of the non-zero coefficients in accordance with the priority mapping order. The remaining non-zero coefficients may be included in the second half of the non-zero coefficients (for example, and may be associated with Group 2).

FIG. 11 is a diagram of an example associated with coefficient prioritization 1100 for a coefficient matrix associated with a PMI, in accordance with the present disclosure. The coefficient matrix depicted in FIG. 11 may be associated with a time domain basis codebook or a Doppler domain basis codebook, as described in more detail elsewhere herein. For example, the codebook may be (W_{f}⊗W₁)W₂Wₜ^{H}, (W_{f}*⊗W₁)W₂Wₜ^{H}, (W_{f}⊗W₁)W₂W_{d}^{H} or (W_{f}*⊗W₁)W₂W_{d}^{H}, where the coefficient matrix W₂ is depicted in FIG. 11.

For example, the coefficient matrix may be the same as, or similar to, the coefficient matrix depicted in FIG. 10. As shown in FIG. 11, the prioritization of the coefficients of the coefficient matrix may be associated with one or more permutations of the coefficient matrix. For example, a frequency domain permutation (for example, Perm_FD(m)) may be performed. The frequency domain permutation may be associated with re-ordering the sets or groups of coefficients in an order indicated by the Perm_FD(m). For example, the order of the frequency domain permutation as depicted in FIG. 10 may be {0, N₃−1, 1, N₃−2, 2, . . . , N₃/2}. This order is provided as an example and other orders are also possible.

In some aspects, the prioritization of the coefficients of the coefficient matrix may be associated with a time domain permutation (for example, Perm_TD(s)). In other examples, the time domain permutation may not be performed. For example, the columns of the coefficient matrix may be re-ordered in accordance with an order indicated by the time domain permutation. For example, the columns of the coefficient matrix may be re-ordered to an order of {0, N₄−1, 1, N₄−2, 2, . . . , N₄/2}.

After permuting the coefficient matrix, the coefficients may be ordered in a priority order. For example, the coefficients may be ordered from a highest priority (for example, priority level 0) to a lowest priority. As shown in FIG. 11, the ordering of the coefficients of the permuted version of the coefficient matrix may include ordering coefficients for the rows for the spatial domain basis indices and the columns for the time domain basis indices for each respective set of the one or more sets in an order of the one or more sets. For example, coefficients may be ordered, for each column in descending order of the rows. All columns and rows associated with a given frequency domain basis index value (for example, a given delay domain index value) may be mapped or ordered before moving to mapping or ordering coefficients associated with a next frequency domain basis index value (for example, a next delay domain index value) as indicated by the order of the frequency domain permutation. For example, all coefficients associated with the delay domain index value 0 may be mapped, then all coefficients associated with the delay domain index value N₃−1 may be mapped, then all coefficients associated with the delay domain index value 2 may be mapped, and so on until all coefficients are mapped to a priority level.

FIG. 12 is a diagram of an example associated with coefficient prioritization 1200 for a coefficient matrix associated with a PMI, in accordance with the present disclosure. The coefficient matrix depicted in FIG. 12 may be associated with a time domain basis codebook or a Doppler domain basis codebook, as described in more detail elsewhere herein. For example, the codebook may be W₁W₂ (Wₜ⊗W_{f})^{H} or W₁W₂ (W_{d}⊗W_{f})^{H} where H is an index of the channel, and where the coefficient matrix W₂ is depicted in FIG. 12.

As shown in FIG. 12, the coefficient matrix may be associated with one or more sets of coefficients (for example, associated with respective Doppler domain index values). Each set, from the one or more sets, may associated with a time domain basis index (for example a Doppler domain index value). Each set includes columns for frequency domain basis indices (for example, delay domain index values) associated with the coefficient matrix and rows for spatial domain basis indices associated with the coefficient matrix.

As shown in FIG. 12, the prioritization of the coefficients of the coefficient matrix may be associated with one or more permutations of the coefficient matrix. For example, a frequency domain permutation (for example, Perm_FD(m)) may be performed. The frequency domain permutation may be associated with re-ordering the columns of the coefficient matrix in an order indicated by the Perm_FD(m). For example, the order of the frequency domain permutation as depicted in FIG. 12 may be {0, N₃−1, 1, N₃−2, 2, . . . , N₃/2}. This order is provided as an example and other orders are also possible.

In some aspects, the prioritization of the coefficients of the coefficient matrix may be associated with a time domain permutation (for example, Perm_TD(s)). In other examples, the time domain permutation may not be performed. For example, the sets of the coefficient matrix may be re-ordered in accordance with an order indicated by the time domain permutation. For example, the sets of the coefficient matrix may be re-ordered to an order of {0, N₄−1, 1, N₄−2, 2, . . . , N₄/2}. This order is provided as an example and other orders are also possible.

After permuting the coefficient matrix, the coefficients may be ordered in a priority order. For example, the coefficients may be ordered from a highest priority (for example, priority level 0) to a lowest priority. As shown in FIG. 12, the ordering of the coefficients of the permuted version of the coefficient matrix may include ordering coefficients for the rows for the spatial domain basis indices and the columns for the frequency domain basis indices (delay domain) for each respective set of the one or more sets in an order of the one or more sets. For example, coefficients may be ordered, for each column in descending order of the rows. All columns and rows associated with a given time domain basis index value (for example, a given Doppler domain index value) may be mapped or ordered before moving to mapping or ordering coefficients associated with a next time domain basis index value (for example, a next Doppler domain index value) as indicated by the order of the time domain permutation. For example, all coefficients associated with the Doppler domain index value 0 may be mapped, then all coefficients associated with the Doppler domain index value N₄-1 may be mapped, then all coefficients associated with the Doppler domain index value 2 may be mapped, and so on until all coefficients are mapped to a priority level.

FIG. 13 is a diagram of an example associated with coefficient prioritization 1300 for a coefficient matrix associated with a PMI, in accordance with the present disclosure. The coefficient matrix depicted in FIG. 12 may be associated with a time domain basis codebook or a Doppler domain basis codebook, as described in more detail elsewhere herein. For example, the codebook may be W₁W₂ (W_{f}⊗Wₜ)^{H} or W₁W₂ (W_{f}⊗W_{d})^{H} where H is an index of the channel, and where the coefficient matrix W₂ is depicted in FIG. 13.

As shown in FIG. 13, the coefficient matrix may be associated with one or more sets of coefficients (for example, associated with respective Doppler domain index values). Each set, from the one or more sets, may associated with a frequency domain basis index (for example a delay domain index value). Each set includes columns for time domain basis indices (for example, Doppler domain index values) associated with the coefficient matrix and rows for spatial domain basis indices associated with the coefficient matrix.

As shown in FIG. 13, the prioritization of the coefficients of the coefficient matrix may be associated with one or more permutations of the coefficient matrix. For example, a frequency domain permutation (for example, Perm_FD(m)) may be performed. The frequency domain permutation may be associated with re-ordering the sets of the coefficient matrix in an order indicated by the Perm_FD(m). For example, the order of the frequency domain permutation as depicted in FIG. 12 may be {0, N₃−1, 1, N₃−2, 2, . . . , N₃/2}. This order is provided as an example and other orders are also possible.

In some aspects, the prioritization of the coefficients of the coefficient matrix may be associated with a time domain permutation (for example, Perm_TD(s)). In other examples, the time domain permutation may not be performed. For example, the columns of the coefficient matrix may be re-ordered in accordance with an order indicated by the time domain permutation. For example, the columns of the coefficient matrix may be re-ordered to an order of {0, N₄−1, 1, N₄−2, 2, . . . , N₄/2}. This order is provided as an example and other orders are also possible.

After permuting the coefficient matrix, the coefficients may be ordered in a priority order. For example, the coefficients may be ordered from a highest priority (for example, priority level 0) to a lowest priority. As shown in FIG. 13, the ordering of the coefficients of the permuted version of the coefficient matrix may include ordering coefficients for the rows for the spatial domain basis indices and the columns for the time domain basis indices for each respective set of the one or more sets in an order of the one or more sets. For example, coefficients may be ordered, for each column in descending order of the rows. All columns and rows associated with a given frequency domain basis index value (for example, a given delay domain index value) may be mapped or ordered before moving to mapping or ordering coefficients associated with a next frequency domain basis index value (for example, a next delay domain index value) as indicated by the order of the frequency domain permutation. For example, all coefficients associated with the delay domain index value 0 may be mapped, then all coefficients associated with the delay domain index value N₃−1 may be mapped, then all coefficients associated with the delay domain index value 2 may be mapped, and so on until all coefficients are mapped to a priority level.

FIG. 14 is a flowchart illustrating an example process 1400 performed, for example, by a UE, associated with UCI packing and prioritization for CSI, in accordance with the present disclosure. Example process 1400 is an example where the UE (for example, UE 120) performs operations associated with uplink control information packing and prioritization for CSI.

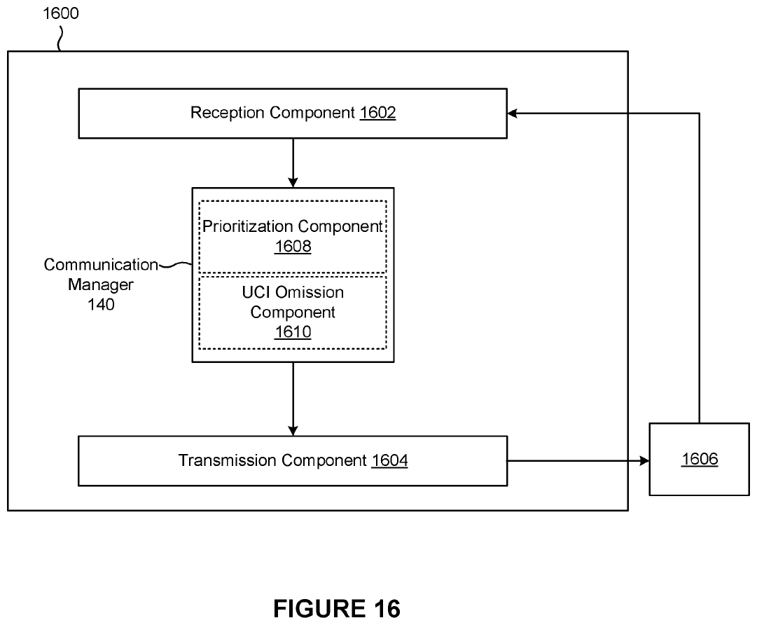

As shown in FIG. 14, in some aspects, process 1400 may include receiving, from a network node, an indication of an uplink resource associated with reporting CSI (block 1410). For example, the UE (such as by using communication manager 140 or reception component 1602, depicted in FIG. 16) may receive, from a network node, an indication of an uplink resource associated with reporting CSI, as described above.

As further shown in FIG. 14, in some aspects, process 1400 may include transmitting, to the network node and using the uplink resource, UCI including a CSI report that indicates PMI values, based at least in part on prioritizing groups of information associated with the CSI report, at least one group, of the groups, being associated with time domain basis index values and non-zero coefficients of a coefficient matrix of a codebook associated with the CSI report (block 1420). For example, the UE (such as by using communication manager 140 or transmission component 1604, depicted in FIG. 16) may transmit, to the network node and using the uplink resource, UCI including a CSI report that indicates PMI values, based at least in part on prioritizing groups of information associated with the CSI report, at least one group, of the groups, being associated with time domain basis index values and non-zero coefficients of a coefficient matrix of a codebook associated with the CSI report, as described above.

Process 1400 may include additional aspects, such as any single aspect or any combination of aspects described below or in connection with one or more other processes described elsewhere herein.

In a first additional aspect, the groups include a first group that is associated with spatial domain beam index values and a strongest coefficient index (SCI), a second group that is associated with frequency domain basis index values, the time domain basis index values, and a first portion of the non-zero coefficients of a coefficient matrix associated with the PMI values, and a third group that is associated with a second portion of the non-zero coefficients of the coefficient matrix, where the at least one group is the second group.

In a second additional aspect, alone or in combination with the first aspect, a size of the uplink resource is insufficient for the CSI report, and transmitting the UCI includes refraining from including one or more PMI values, from the PMI values, based at least in part on including information in an order in which information associated with the first group is included in the CSI report first, followed by information associated with the second group, and further followed by information associated with the third group.

In a third additional aspect, alone or in combination with one or more of the first and second aspects, the first portion of the non-zero coefficients includes a first half of the non-zero coefficients and the second portion of the non-zero coefficients includes a second half of the non-zero coefficients.

In a fourth additional aspect, alone or in combination with one or more of the first through third aspects, the codebook includes a time domain basis codebook or a Doppler domain basis codebook.

In a fifth additional aspect, alone or in combination with one or more of the first through fourth aspects, a first portion of the non-zero coefficients and a second portion of the non-zero coefficients are selected based at least in part on a prioritization of the non-zero coefficients.

In a sixth additional aspect, alone or in combination with one or more of the first through fifth aspects, the prioritization of the non-zero coefficients includes ordering the non-zero coefficients based at least in part on a permuted version of the coefficient matrix, where the permuted version include at least one of the time domain permutation and a frequency domain permutation.

In a seventh additional aspect, alone or in combination with one or more of the first through sixth aspects, the time domain permutation is associated with a Doppler domain and the frequency domain permutation is associated with a delay domain.

In an eighth additional aspect, alone or in combination with one or more of the first through seventh aspects, the ordering of the non-zero coefficients includes ordering coefficients of the permuted version of the coefficient matrix of all frequency domain indices and spatial domain indices for each respective time domain index of the permuted version of the coefficient matrix.

In a ninth additional aspect, alone or in combination with one or more of the first through eighth aspects, the ordering of the non-zero coefficients includes ordering coefficients of the permuted version of the coefficient matrix of all time domain indices and spatial domain indices for each respective frequency domain index of the permuted version of the coefficient matrix.

In a tenth additional aspect, alone or in combination with one or more of the first through ninth aspects, the coefficient matrix is associated with one or more sets of coefficients, where each set, from the one or more sets, is associated with a respective frequency domain basis index, and where each set includes columns for time domain basis indices associated with the coefficient matrix and rows for spatial domain basis indices associated with the coefficient matrix, and where the ordering of the non-zero coefficients includes ordering coefficients of the permuted version of the coefficient matrix by ordering coefficients for the rows for the spatial domain basis indices, and the one or more sets, associated with each respective column, of the columns for the time domain basis indices, in an order of the columns.

In an eleventh additional aspect, alone or in combination with one or more of the first through tenth aspects, the coefficient matrix is associated with one or more sets of coefficients, where each set, from the one or more sets, is associated with a frequency domain basis index, and where each set includes columns for time domain basis indices associated with the coefficient matrix and rows for spatial domain basis indices associated with the coefficient matrix, and where the ordering of the non-zero coefficients includes ordering coefficients of the permuted version of the coefficient matrix by ordering coefficients for the rows for the spatial domain basis indices and the columns for the time domain basis indices for each respective set of the one or more sets in an order of the one or more sets.

In a twelfth additional aspect, alone or in combination with one or more of the first through eleventh aspects, the coefficient matrix is associated with one or more sets of coefficients, where each set, from the one or more sets, is associated with a time domain basis index, and where each set includes columns for frequency domain basis indices associated with the coefficient matrix and rows for spatial domain basis indices associated with the coefficient matrix, and where the ordering of the non-zero coefficients includes ordering coefficients of the permuted version of the coefficient matrix by ordering coefficients for the rows for the spatial domain basis indices and the columns for the frequency domain basis indices for each respective set of the one or more sets in an order of the one or more sets.

In a thirteenth additional aspect, alone or in combination with one or more of the first through twelfth aspects, a size of the uplink resource is insufficient for the CSI report, and transmitting the UCI includes refraining from including one or more PMI values, from the PMI values, based at least in part on omitting information associated with at least one group from the groups based at least in part on prioritizing the groups.

In a fourteenth additional aspect, alone or in combination with one or more of the first through thirteenth aspects, the UCI is associated with multiple CSI reports, including the CSI report, and refraining from including the one or more PMI values is based at least in part on prioritizing CSI reports, from the multiple CSI reports, in an order of index values of the multiple CSI reports.

Although FIG. 14 shows example blocks of process 1400, in some aspects, process 1400 may include additional blocks, fewer blocks, different blocks, or differently arranged blocks than those depicted in FIG. 14. Additionally or alternatively, two or more of the blocks of process 1400 may be performed in parallel.

FIG. 15 is a flowchart illustrating an example process 1500 performed, for example, by a network node, associated with UCI packing and prioritization for CSI, in accordance with the present disclosure. Example process 1500 is an example where the network node (for example, network node 110) performs operations associated with UCI packing and prioritization for CSI.

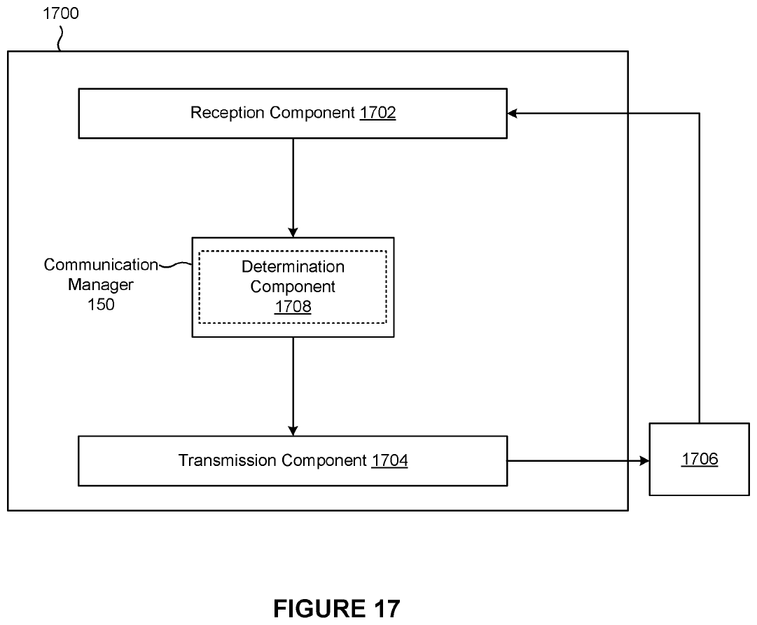

As shown in FIG. 15, in some aspects, process 1500 may include transmitting an indication of an uplink resource, intended for a UE, associated with reporting CSI (block 1510). For example, the network node (such as by using communication manager 150 or transmission component 1704, depicted in FIG. 17) may transmit an indication of an uplink resource, intended for a UE, associated with reporting CSI, as described above.

As further shown in FIG. 15, in some aspects, process 1500 may include receiving UCI associated with the UE and the uplink resource, the UCI including a CSI report that indicates PMI values, the UCI being associated with groups for prioritization of information associated with the CSI report, at least one group, of the groups, being associated with time domain basis index values and non-zero coefficients of a coefficient matrix of a codebook associated with the CSI report (block 1520). For example, the network node (such as by using communication manager 150 or reception component 1702, depicted in FIG. 17) may receive UCI associated with the UE and the uplink resource, the UCI including a CSI report that indicates PMI values, the UCI being associated with groups for prioritization of information associated with the CSI report, at least one group, of the groups, being associated with time domain basis index values and non-zero coefficients of a coefficient matrix of a codebook associated with the CSI report, as described above.

Process 1500 may include additional aspects, such as any single aspect or any combination of aspects described below or in connection with one or more other processes described elsewhere herein.

In a first additional aspect, the groups include a first group that is associated with spatial domain beam index values and a strongest coefficient index, a second group that is associated with frequency domain index values, the time domain index values, and a first portion of the non-zero coefficients, and a third group that is associated with a second portion of the non-zero coefficients of the coefficient matrix, where the at least one group is the second group.

In a second additional aspect, alone or in combination with the first aspect, a size of the uplink resource is insufficient for the CSI report, and the UCI does not include one or more PMI values, from the PMI values, based at least in part on information being prioritized in an order in which information associated with the first group is included in the CSI report first, followed by information associated with the second group, and further followed by information associated with the third group.

In a third additional aspect, alone or in combination with one or more of the first and second aspects, the first portion of the non-zero coefficients includes a first half of the non-zero coefficients and the second portion of the non-zero coefficients includes a second half of the non-zero coefficients.

In a fourth additional aspect, alone or in combination with one or more of the first through third aspects, with the codebook includes a time domain basis codebook or a Doppler domain basis codebook.

In a fifth additional aspect, alone or in combination with one or more of the first through fourth aspects, a first portion of the non-zero coefficients and a second portion of the non-zero coefficients are selected based at least in part on a prioritization of the non-zero coefficients.

In a sixth additional aspect, alone or in combination with one or more of the first through fifth aspects, the prioritization of the non-zero coefficients includes ordering the non-zero coefficients based at least in part on a permuted version of the coefficient matrix, where the permuted version includes at least one of a time domain permutation and a frequency domain permutation.

In a seventh additional aspect, alone or in combination with one or more of the first through sixth aspects, the time domain permutation is associated with a Doppler domain and the frequency domain permutation is associated with a delay domain.

In an eighth additional aspect, alone or in combination with one or more of the first through seventh aspects, the ordering of the non-zero coefficients includes ordering coefficients of the permuted version of the coefficient matrix of all frequency domain indices and spatial domain indices for each respective time domain index of the permuted version of the coefficient matrix.

In a ninth additional aspect, alone or in combination with one or more of the first through eighth aspects, the ordering of the non-zero coefficients includes ordering coefficients of the permuted version of the coefficient matrix of all time domain indices and spatial domain indices for each respective frequency domain index of the permuted version of the coefficient matrix.

In a tenth additional aspect, alone or in combination with one or more of the first through ninth aspects, the coefficient matrix is associated with one or more sets of coefficients, where each set, from the one or more sets, is associated with a respective frequency domain basis index, and where each set includes columns for time domain basis indices associated with the coefficient matrix and rows for spatial domain basis indices associated with the coefficient matrix, and where the ordering of the non-zero coefficients includes ordering coefficients of the permuted version of the coefficient matrix by ordering coefficients for the rows for the spatial domain basis indices, and the one or more sets, associated with each respective column, of the columns for the time domain basis indices, in an order of the columns.

In an eleventh additional aspect, alone or in combination with one or more of the first through tenth aspects, the coefficient matrix is associated with one or more sets of coefficients, where each set, from the one or more sets, is associated with a frequency domain basis index, and where each set includes columns for time domain basis indices associated with the coefficient matrix and rows for spatial domain basis indices associated with the coefficient matrix, and where the ordering of the non-zero coefficients includes ordering coefficients of the permuted version of the coefficient matrix by ordering coefficients for the rows for the spatial domain basis indices and the columns for the time domain basis indices for each respective set of the one or more sets in an order of the one or more sets.

In a twelfth additional aspect, alone or in combination with one or more of the first through eleventh aspects, the coefficient matrix is associated with one or more sets of coefficients, where each set, from the one or more sets, is associated with a time domain basis index, and where each set includes columns for frequency domain basis indices associated with the coefficient matrix and rows for spatial domain basis indices associated with the coefficient matrix, and where the ordering of the non-zero coefficients includes ordering coefficients of the permuted version of the coefficient matrix by ordering coefficients for the rows for the spatial domain basis indices and the columns for the frequency domain basis indices for each respective set of the one or more sets in an order of the one or more sets.

In a thirteenth additional aspect, alone or in combination with one or more of the first through twelfth aspects, the groups include a first group that is associated with spatial domain beam index values and strongest coefficient index values, a second group that is associated with frequency domain index values, the time domain index values, and a first portion of the non-zero coefficients, and a third group that is associated with a second portion of the non-zero coefficients of the coefficient matrix, and where the UCI does not include one or more PMI values, from the PMI values, based at least in part on information associated with one or more groups being omitted based at least in part on prioritizing the first group over the second group and the third group and based at least in part on prioritizing the second group over the third group.

In a fourteenth additional aspect, alone or in combination with one or more of the first through thirteenth aspects, the UCI is associated with multiple CSI reports, including the CSI report, and the information associated with one or more groups being omitted is further based at least in part on prioritizing CSI reports, from the multiple CSI reports, in an order of index values of the multiple CSI reports.

Although FIG. 15 shows example blocks of process 1500, in some aspects, process 1500 may include additional blocks, fewer blocks, different blocks, or differently arranged blocks than those depicted in FIG. 15. Additionally or alternatively, two or more of the blocks of process 1500 may be performed in parallel.

FIG. 16 is a diagram of an example apparatus 1600 for wireless communication in accordance with the present disclosure. The apparatus 1600 may be a UE, or a UE may include the apparatus 1600. In some aspects, the apparatus 1600 includes a reception component 1602, a transmission component 1604, and a communication manager 140, which may be in communication with one another (for example, via one or more buses). As shown, the apparatus 1600 may communicate with another apparatus 1606 (such as a UE, a network node, or another wireless communication device) using the reception component 1602 and the transmission component 1604.

In some aspects, the apparatus 1600 may be configured to perform one or more operations described herein in connection with FIGS. 8-13. Additionally or alternatively, the apparatus 1600 may be configured to perform one or more processes described herein, such as process 1400 of FIG. 14, or a combination thereof. In some aspects, the apparatus 1600 may include one or more components of the UE described above in connection with FIG. 2.

The reception component 1602 may receive communications, such as reference signals, control information, data communications, or a combination thereof, from the apparatus 1606. The reception component 1602 may provide received communications to one or more other components of the apparatus 1600, such as the communication manager 140. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1602 may include one or more antennas, a modem, a demodulator, a MIMO detector, a receive processor, a controller/processor, a memory, or a combination thereof, of the UE described above in connection with FIG. 2.

The transmission component 1604 may transmit communications, such as reference signals, control information, data communications, or a combination thereof, to the apparatus 1606. In some aspects, the communication manager 140 may generate communications and may transmit the generated communications to the transmission component 1604 for transmission to the apparatus 1606. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1606. In some aspects, the transmission component 1604 may include one or more antennas, a modem, a modulator, a transmit MIMO processor, a transmit processor, a controller/processor, a memory, or a combination thereof, of the UE described above in connection with FIG. 2. In some aspects, the transmission component 1604 may be co-located with the reception component 1602 in a transceiver.

The communication manager 140 may receive or may cause the reception component 1602 to receive, from a network node, an indication of an uplink resource associated with reporting CSI. The communication manager 140 may transmit or may cause the transmission component 1604 to transmit, to the network node and using the uplink resource, UCI including a CSI report that indicates PMI values, based at least in part on prioritizing groups of information associated with the CSI report, at least one group, of the groups, being associated with time domain basis index values and non-zero coefficients of a coefficient matrix of a codebook associated with the CSI report. In some aspects, the communication manager 140 may perform one or more operations described elsewhere herein as being performed by one or more components of the communication manager 140.

The communication manager 140 may include a controller/processor, a memory, or a combination thereof, of the UE described above in connection with FIG. 2. In some aspects, the communication manager 140 includes a set of components, such as a prioritization component 1608, a UCI omission component 1610, or a combination thereof. Alternatively, the set of components may be separate and distinct from the communication manager 140. In some aspects, one or more components of the set of components may include or may be implemented within a controller/processor, a memory, or a combination thereof, of the UE described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive, from a network node, an indication of an uplink resource associated with reporting CSI. The transmission component 1604 may transmit, to the network node and using the uplink resource, UCI including a CSI report that indicates PMI values, based at least in part on prioritizing groups of information associated with the CSI report, at least one group, of the groups, being associated with time domain basis index values and non-zero coefficients of a coefficient matrix of a codebook associated with the CSI report.

The prioritization component 1608 may prioritize one or more groups. The prioritization component 1608 may prioritize coefficients associated with the coefficient matrix based at least in part on an ordering of the coefficients. The UCI omission component 1610 may omit information from the UCI based at least in part on a size of the uplink resource being insufficient.

The quantity and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally or alternatively, a set of (one or more) components shown in FIG. 16 may perform one or more functions described as being performed by another set of components shown in FIG. 16.

FIG. 17 is a diagram of an example apparatus 1700 for wireless communication in accordance with the present disclosure. The apparatus 1700 may be a network node, or a network node may include the apparatus 1700. In some aspects, the apparatus 1700 includes a reception component 1702, a transmission component 1704, and a communication manager 150, which may be in communication with one another (for example, via one or more buses). As shown, the apparatus 1700 may communicate with another apparatus 1706 (such as a UE, a network node, or another wireless communication device) using the reception component 1702 and the transmission component 1704.

In some aspects, the apparatus 1700 may be configured to perform one or more operations described herein in connection with FIGS. 8-13. Additionally or alternatively, the apparatus 1700 may be configured to perform one or more processes described herein, such as process 1500 of FIG. 15, or a combination thereof. In some aspects, the apparatus 1700 may include one or more components of the network node described above in connection with FIG. 2.

The reception component 1702 may receive communications, such as reference signals, control information, data communications, or a combination thereof, from the apparatus 1706. The reception component 1702 may provide received communications to one or more other components of the apparatus 1700, such as the communication manager 150. In some aspects, the reception component 1702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1702 may include one or more antennas, a modem, a demodulator, a MIMO detector, a receive processor, a controller/processor, a memory, or a combination thereof, of the network node described above in connection with FIG. 2.

The transmission component 1704 may transmit communications, such as reference signals, control information, data communications, or a combination thereof, to the apparatus 1706. In some aspects, the communication manager 150 may generate communications and may transmit the generated communications to the transmission component 1704 for transmission to the apparatus 1706. In some aspects, the transmission component 1704 may perform signal processing on the generated communications (such as filtering, amplification, modulation, digital-to-analog conversion, multiplexing, interleaving, mapping, or encoding, among other examples), and may transmit the processed signals to the apparatus 1706. In some aspects, the transmission component 1704 may include one or more antennas, a modem, a modulator, a transmit MIMO processor, a transmit processor, a controller/processor, a memory, or a combination thereof, of the network node described above in connection with FIG. 2. In some aspects, the transmission component 1704 may be co-located with the reception component 1702 in a transceiver.

The communication manager 150 may transmit or may cause the transmission component 1704 to transmit an indication of an uplink resource, intended for a UE, associated with reporting CSI. The communication manager 150 may receive or may cause the reception component 1702 to receive UCI associated with the UE and the uplink resource, the UCI including a CSI report that indicates PMI values, the UCI being associated with groups for packing prioritization for the uplink resource, at least one group of the groups being associated with time domain basis index values and non-zero coefficients of a coefficient matrix. In some aspects, the communication manager 150 may perform one or more operations described elsewhere herein as being performed by one or more components of the communication manager 150.

The communication manager 150 may include a controller/processor, a memory, a scheduler, a communication unit, or a combination thereof, of the network node described above in connection with FIG. 2. In some aspects, the communication manager 150 includes a set of components, such as a determination component 1708, or a combination thereof. Alternatively, the set of components may be separate and distinct from the communication manager 150. In some aspects, one or more components of the set of components may include or may be implemented within a controller/processor, a memory, a scheduler, a communication unit, or a combination thereof, of the network node described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The transmission component 1704 may transmit an indication of an uplink resource, intended for a UE, associated with reporting CSI. The reception component 1702 may receive UCI associated with the UE and the uplink resource, the UCI including a CSI report that indicates PMI values, the UCI being associated with groups for packing prioritization for the uplink resource, at least one group of the groups being associated with time domain basis index values and non-zero coefficients of a coefficient matrix.

The determination component 1708 may determine a precoder for the UE based at least in part on the CSI report.

The quantity and arrangement of components shown in FIG. 17 are provided as an example. In practice, there may be additional components, fewer components, different components, or differently arranged components than those shown in FIG. 17. Furthermore, two or more components shown in FIG. 17 may be implemented within a single component, or a single component shown in FIG. 17 may be implemented as multiple, distributed components. Additionally or alternatively, a set of (one or more) components shown in FIG. 17 may perform one or more functions described as being performed by another set of components shown in FIG. 17.

The following provides an overview of some Aspects of the present disclosure:
Aspect 1: A method of wireless communication performed by a user equipment (UE), comprising: receiving, from a network node, an indication of an uplink resource associated with reporting channel state information (CSI); and transmitting, to the network node and using the uplink resource, uplink control information (UCI) including a CSI report that indicates precoding matrix indicator (PMI) values, based at least in part on prioritizing groups of information associated with the CSI report, at least one group, of the groups, being associated with time domain basis index values and non-zero coefficients of a coefficient matrix of a codebook associated with the CSI report.
Aspect 2: The method of Aspect 1, wherein the groups include a first group that is associated with spatial domain beam index values and a strongest coefficient index (SCI); a second group that is associated with frequency domain basis index values, the time domain basis index values, and a first portion of the non-zero coefficients of a coefficient matrix associated with the PMI values; and a third group that is associated with a second portion of the non-zero coefficients of the coefficient matrix, wherein the at least one group is the second group.
Aspect 3: The method of Aspect 2, wherein a size of the uplink resource is insufficient for the CSI report, and wherein transmitting the UCI comprises refraining from including one or more PMI values, from the PMI values, based at least in part on including information in an order in which information associated with the first group is included in the CSI report first, followed by information associated with the second group, and further followed by information associated with the third group.
Aspect 4: The method of any of Aspects 2-3, wherein the first portion of the non-zero coefficients includes a first half of the non-zero coefficients and the second portion of the non-zero coefficients includes a second half of the non-zero coefficients.
Aspect 5: The method of any of Aspects 1-4, wherein with the codebook includes a time domain basis codebook or a Doppler domain basis codebook.
Aspect 6: The method of any of Aspects 1-5, wherein a first portion of the non-zero coefficients and a second portion of the non-zero coefficients are selected based at least in part on a prioritization of the non-zero coefficients.
Aspect 7: The method of Aspect 6, wherein the prioritization of the non-zero coefficients includes ordering the non-zero coefficients based at least in part on a permuted version of the coefficient matrix, wherein the permuted version include at least one of the time domain permutation and a frequency domain permutation.
Aspect 8: The method of Aspect 7, wherein the time domain permutation is associated with a Doppler domain and the frequency domain permutation is associated with a delay domain.
Aspect 9: The method of any of Aspects 7-8, wherein the ordering of the non-zero coefficients includes ordering coefficients of the permuted version of the coefficient matrix of all frequency domain indices and spatial domain indices for each respective time domain index of the permuted version of the coefficient matrix.
Aspect 10: The method of any of Aspects 7-8, wherein the ordering of the non-zero coefficients includes ordering coefficients of the permuted version of the coefficient matrix by ordering time domain indices and spatial domain indices for each respective frequency domain index of the permuted version of the coefficient matrix.
Aspect 11: The method of any of Aspects 7-10, wherein the coefficient matrix is associated with one or more sets of coefficients, wherein each set, from the one or more sets, is associated with a respective frequency domain basis index, and wherein each set includes columns for time domain basis indices associated with the coefficient matrix and rows for spatial domain basis indices associated with the coefficient matrix, and wherein the ordering of the non-zero coefficients includes ordering coefficients of the permuted version of the coefficient matrix by ordering coefficients for the rows for the spatial domain basis indices, and the one or more sets, associated with each respective column, of the columns for the time domain basis indices, in an order of the columns.
Aspect 12: The method of any of Aspects 7-10, wherein the coefficient matrix is associated with one or more sets of coefficients, wherein each set, from the one or more sets, is associated with a frequency domain basis index, and wherein each set includes columns for time domain basis indices associated with the coefficient matrix and rows for spatial domain basis indices associated with the coefficient matrix, and wherein the ordering of the non-zero coefficients includes ordering coefficients of the permuted version of the coefficient matrix by ordering coefficients for the rows for the spatial domain basis indices and the columns for the time domain basis indices for each respective set of the one or more sets in an order of the one or more sets.
Aspect 13: The method of any of Aspects 7-10, wherein the coefficient matrix is associated with one or more sets of coefficients, wherein each set, from the one or more sets, is associated with a time domain basis index, and wherein each set includes columns for frequency domain basis indices associated with the coefficient matrix and rows for spatial domain basis indices associated with the coefficient matrix, and wherein the ordering of the non-zero coefficients includes ordering coefficients of the permuted version of the coefficient matrix by ordering coefficients for the rows for the spatial domain basis indices and the columns for the frequency domain basis indices for each respective set of the one or more sets in an order of the one or more sets.
Aspect 14: The method of any of Aspects 1-13, wherein a size of the uplink resource is insufficient for the CSI report, and wherein transmitting the UCI comprises refraining from including one or more PMI values, from the PMI values, based at least in part on omitting information associated with at least one group from the groups based at least in part on prioritizing the groups.
Aspect 15: The method of Aspect 14, wherein the UCI is associated with multiple CSI reports, including the CSI report, and wherein refraining from including the one or more PMI values is based at least in part on prioritizing CSI reports, from the multiple CSI reports, in an order of index values of the multiple CSI reports.
Aspect 16: A method of wireless communication performed by a network node, comprising: transmitting an indication of an uplink resource, intended for a user equipment (UE), associated with reporting channel state information (CSI); and receiving uplink control information (UCI) associated with the UE and the uplink resource, the UCI including a CSI report that indicates precoding matrix indicator (PMI) values, the UCI being associated with groups for prioritization of information associated with the CSI report, at least one group, of the groups, being associated with time domain basis index values and non-zero coefficients of a coefficient matrix of a codebook associated with the CSI report.
Aspect 17: The method of Aspect 16, wherein the groups include a first group that is associated with spatial domain beam index values and a strongest coefficient index (SCI); a second group that is associated with frequency domain index values, the time domain index values, and a first portion of the non-zero coefficients; and a third group that is associated with a second portion of the non-zero coefficients of the coefficient matrix, wherein the at least one group is the second group.
Aspect 18: The method of Aspect 17, wherein a size of the uplink resource is insufficient for the CSI report, and wherein the UCI does not include one or more PMI values, from the PMI values, based at least in part on information being prioritized in an order in which information associated with the first group is included in the CSI report first, followed by information associated with the second group, and further followed by information associated with the third group.
Aspect 19: The method of any of Aspects 17-18, wherein the first portion of the non-zero coefficients includes a first half of the non-zero coefficients and the second portion of the non-zero coefficients includes a second half of the non-zero coefficients.
Aspect 20: The method of any of Aspects 16-19, wherein with the codebook includes a time domain basis codebook or a Doppler domain basis codebook.
Aspect 21: The method of any of Aspects 16-20, wherein a first portion of the non-zero coefficients and a second portion of the non-zero coefficients are selected based at least in part on a prioritization of the non-zero coefficients.
Aspect 22: The method of Aspect 21, wherein the prioritization of the non-zero coefficients includes ordering the non-zero coefficients based at least in part on a permuted version of the coefficient matrix, wherein the permuted version includes at least one of a time domain permutation and a frequency domain permutation.
Aspect 23: The method of Aspect 22, wherein the time domain permutation is associated with a Doppler domain and the frequency domain permutation is associated with a delay domain.
Aspect 24: The method of any of Aspects 22-23, wherein the ordering of the non-zero coefficients includes ordering coefficients of the permuted version of the coefficient matrix of all frequency domain indices and spatial domain indices for each respective time domain index of the permuted version of the coefficient matrix.
Aspect 25: The method of any of Aspects 22-23, wherein the ordering of the non-zero coefficients includes ordering coefficients of the permuted version of the coefficient matrix by ordering time domain indices and spatial domain indices for each respective frequency domain index of the permuted version of the coefficient matrix.
Aspect 26: The method of any of Aspects 22-25, wherein the coefficient matrix is associated with one or more sets of coefficients, wherein each set, from the one or more sets, is associated with a respective frequency domain basis index, and wherein each set includes columns for time domain basis indices associated with the coefficient matrix and rows for spatial domain basis indices associated with the coefficient matrix, and wherein the ordering of the non-zero coefficients includes ordering coefficients of the permuted version of the coefficient matrix by ordering coefficients for the rows for the spatial domain basis indices, and the one or more sets, associated with each respective column, of the columns for the time domain basis indices, in an order of the columns.
Aspect 27: The method of any of Aspects 22-25, wherein the coefficient matrix is associated with one or more sets of coefficients, wherein each set, from the one or more sets, is associated with a frequency domain basis index, and wherein each set includes columns for time domain basis indices associated with the coefficient matrix and rows for spatial domain basis indices associated with the coefficient matrix, and wherein the ordering of the non-zero coefficients includes ordering coefficients of the permuted version of the coefficient matrix by ordering coefficients for the rows for the spatial domain basis indices and the columns for the time domain basis indices for each respective set of the one or more sets in an order of the one or more sets.
Aspect 28: The method of any of Aspects 22-25, wherein the coefficient matrix is associated with one or more sets of coefficients, wherein each set, from the one or more sets, is associated with a time domain basis index, and wherein each set includes columns for frequency domain basis indices associated with the coefficient matrix and rows for spatial domain basis indices associated with the coefficient matrix, and wherein the ordering of the non-zero coefficients includes ordering coefficients of the permuted version of the coefficient matrix by ordering coefficients for the rows for the spatial domain basis indices and the columns for the frequency domain basis indices for each respective set of the one or more sets in an order of the one or more sets.
Aspect 29: The method of any of Aspects 16-28, wherein the groups include a first group that is associated with spatial domain beam index values and strongest coefficient index values; a second group that is associated with frequency domain index values, the time domain index values, and a first portion of the non-zero coefficients; and a third group that is associated with a second portion of the non-zero coefficients of the coefficient matrix, and wherein the UCI does not include one or more PMI values, from the PMI values, based at least in part on information associated with one or more groups being omitted based at least in part on prioritizing the first group over the second group and the third group and based at least in part on prioritizing the second group over the third group.
Aspect 30: The method of Aspect 29, wherein the UCI is associated with multiple CSI reports, including the CSI report, and wherein the information associated with one or more groups being omitted is further based at least in part on prioritizing CSI reports, from the multiple CSI reports, in an order of index values of the multiple CSI reports.
Aspect 31: An apparatus for wireless communication at a device, comprising a processor; memory coupled with the processor; and instructions stored in the memory and executable by the processor to cause the apparatus to perform the method of one or more of Aspects 1-15.
Aspect 32: A device for wireless communication, comprising a memory and one or more processors coupled to the memory, the one or more processors configured to perform the method of one or more of Aspects 1-15.
Aspect 33: An apparatus for wireless communication, comprising at least one means for performing the method of one or more of Aspects 1-15.
Aspect 34: A non-transitory computer-readable medium storing code for wireless communication, the code comprising instructions executable by a processor to perform the method of one or more of Aspects 1-15.
Aspect 35: A non-transitory computer-readable medium storing a set of instructions for wireless communication, the set of instructions comprising one or more instructions that, when executed by one or more processors of a device, cause the device to perform the method of one or more of Aspects 1-15.
Aspect 36: An apparatus for wireless communication at a device, comprising a processor; memory coupled with the processor; and instructions stored in the memory and executable by the processor to cause the apparatus to perform the method of one or more of Aspects 16-30.
Aspect 37: A device for wireless communication, comprising a memory and one or more processors coupled to the memory, the one or more processors configured to perform the method of one or more of Aspects 16-30.
Aspect 38: An apparatus for wireless communication, comprising at least one means for performing the method of one or more of Aspects 16-30.
Aspect 39: A non-transitory computer-readable medium storing code for wireless communication, the code comprising instructions executable by a processor to perform the method of one or more of Aspects 16-30.
Aspect 40: A non-transitory computer-readable medium storing a set of instructions for wireless communication, the set of instructions comprising one or more instructions that, when executed by one or more processors of a device, cause the device to perform the method of one or more of Aspects 16-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (for example, if used in combination with “either” or “only one of”).

What is claimed is:

1. A user equipment (UE) for wireless communication, comprising:
at least one memory; and
at least one processor communicatively coupled with the at least one memory, the at least one processor configured to cause the UE to:
receive, from a network node, an indication of an uplink resource associated with reporting channel state information (CSI); and
transmit, to the network node and using the uplink resource, uplink control information (UCI) including a CSI report that indicates precoding matrix indicator (PMI) values, based at least in part on prioritizing groups of information associated with the CSI report, at least one group, of the groups, being associated with time domain basis index values and non-zero coefficients of a coefficient matrix of a codebook associated with the CSI report.

2. The UE of claim 1, wherein the groups include a first group that is associated with spatial domain beam index values and a strongest coefficient index (SCI); a second group that is associated with frequency domain basis index values, the time domain basis index values, and a first portion of the non-zero coefficients of a coefficient matrix associated with the PMI values; and a third group that is associated with a second portion of the non-zero coefficients of the coefficient matrix, wherein the at least one group is the second group.

3. The UE of claim 2, wherein a size of the uplink resource is insufficient for the CSI report, and wherein the at least one processor, to transmit the UCI, is configured to cause the UE to refrain from including one or more PMI values, from the PMI values, based at least in part on including information in an order in which information associated with the first group is included in the CSI report first, followed by information associated with the second group, and further followed by information associated with the third group.

4. The UE of claim 1, wherein a first portion of the non-zero coefficients and a second portion of the non-zero coefficients are selected based at least in part on a prioritization of the non-zero coefficients.

5. The UE of claim 4, wherein the prioritization of the non-zero coefficients includes ordering the non-zero coefficients based at least in part on a permuted version of the coefficient matrix, wherein the permuted version include at least one of a time domain permutation and a frequency domain permutation.

6. The UE of claim 5, wherein the ordering of the non-zero coefficients includes ordering coefficients of the permuted version of the coefficient matrix of all frequency domain indices and spatial domain indices for each respective time domain index of the permuted version of the coefficient matrix.

7. The UE of claim 5, wherein the ordering of the non-zero coefficients includes ordering coefficients of the permuted version of the coefficient matrix of all time domain indices and spatial domain indices for each respective frequency domain index of the permuted version of the coefficient matrix.

8. The UE of claim 5, wherein the coefficient matrix is associated with one or more sets of coefficients, wherein each set, from the one or more sets, is associated with a respective frequency domain basis index, and wherein each set includes columns for time domain basis indices associated with the coefficient matrix and rows for spatial domain basis indices associated with the coefficient matrix, and
wherein the ordering of the non-zero coefficients includes ordering coefficients of the permuted version of the coefficient matrix by ordering coefficients for the rows for the spatial domain basis indices, and the one or more sets, associated with each respective column, of the columns for the time domain basis indices, in an order of the columns.

9. The UE of claim 5, wherein the coefficient matrix is associated with one or more sets of coefficients, wherein each set, from the one or more sets, is associated with a frequency domain basis index, and wherein each set includes columns for time domain basis indices associated with the coefficient matrix and rows for spatial domain basis indices associated with the coefficient matrix, and
wherein the ordering of the non-zero coefficients includes ordering coefficients of the permuted version of the coefficient matrix by ordering coefficients for the rows for the spatial domain basis indices and the columns for the time domain basis indices for each respective set of the one or more sets in an order of the one or more sets.

10. The UE of claim 5, wherein the coefficient matrix is associated with one or more sets of coefficients, wherein each set, from the one or more sets, is associated with a time domain basis index, and wherein each set includes columns for frequency domain basis indices associated with the coefficient matrix and rows for spatial domain basis indices associated with the coefficient matrix, and
wherein the ordering of the non-zero coefficients includes ordering coefficients of the permuted version of the coefficient matrix by ordering coefficients for the rows for the spatial domain basis indices and the columns for the frequency domain basis indices for each respective set of the one or more sets in an order of the one or more sets.

11. The UE of claim 1, wherein a size of the uplink resource is insufficient for the CSI report, and wherein the at least one processor, to transmit the UCI, is configured to cause the UE to refrain from including one or more PMI values, from the PMI values, based at least in part on omitting information associated with at least one group from the groups based at least in part on prioritizing the groups.

12. The UE of claim 11, wherein the UCI is associated with multiple CSI reports, including the CSI report, and wherein refraining from including the one or more PMI values is based at least in part on prioritizing CSI reports, from the multiple CSI reports, in an order of index values of the multiple CSI reports.

13. A network node for wireless communication, comprising:
at least one memory; and
at least one processor communicatively coupled with the at least one memory, the at least one processor configured to cause the network node to:
transmit an indication of an uplink resource, intended for a user equipment (UE), associated with reporting channel state information (CSI); and
receive uplink control information (UCI) associated with the UE and the uplink resource, the UCI including a CSI report that indicates precoding matrix indicator (PMI) values, the UCI being associated with groups for prioritization of information associated with the CSI report, at least one group, of the groups, being associated with time domain basis index values and non-zero coefficients of a coefficient matrix of a codebook associated with the CSI report.

14. The network node of claim 13, wherein the groups include a first group that is associated with spatial domain beam index values and strongest coefficient index values; a second group that is associated with frequency domain index values, the time domain index values, and a first portion of the non-zero coefficients; and a third group that is associated with a second portion of the non-zero coefficients of the coefficient matrix, wherein the at least one group is the second group.

15. The network node of claim 13, wherein a prioritization of the non-zero coefficients includes ordering the non-zero coefficients based at least in part on a permuted version of the coefficient matrix, wherein the permuted version includes at least one of a time domain permutation and a frequency domain permutation, and wherein the ordering of the non-zero coefficients includes ordering coefficients of the permuted version of the coefficient matrix by ordering frequency domain indices and spatial domain indices for each respective time domain index of the permuted version of the coefficient matrix.

16. A method of wireless communication performed by a user equipment (UE), comprising:
receiving, from a network node, an indication of an uplink resource associated with reporting channel state information (CSI); and
transmitting, to the network node and using the uplink resource, uplink control information (UCI) including a CSI report that indicates precoding matrix indicator (PMI) values, based at least in part on prioritizing groups of information associated with the CSI report, at least one group, of the groups, being associated with time domain basis index values and non-zero coefficients of a coefficient matrix of a codebook associated with the CSI report.

17. The method of claim 16, wherein the groups include a first group that is associated with spatial domain beam index values and strongest coefficient index values; a second group that is associated with frequency domain basis index values, the time domain basis index values, and a first portion of the non-zero coefficients of a coefficient matrix associated with the PMI values; and a third group that is associated with a second portion of the non-zero coefficients of the coefficient matrix, wherein the at least one group is the second group.

18. The method of claim 17, wherein a size of the uplink resource is insufficient for the CSI report, and wherein transmitting the UCI comprises refraining from including one or more PMI values, from the PMI values, based at least in part on including information in an order in which information associated with the first group is included in the CSI report first, followed by information associated with the second group, and further followed by information associated with the third group.

19. The method of claim 16, wherein a first portion of the non-zero coefficients and a second portion of the non-zero coefficients are selected based at least in part on a prioritization of the non-zero coefficients.

20. The method of claim 19, wherein the prioritization of the non-zero coefficients includes ordering the non-zero coefficients based at least in part on a permuted version of the coefficient matrix, wherein the permuted version include at least one of a time domain permutation and a frequency domain permutation.

21. The method of claim 20, wherein the ordering of the non-zero coefficients includes ordering coefficients of the permuted version of the coefficient matrix of all frequency domain indices and spatial domain indices for each respective time domain index of the permuted version of the coefficient matrix.

22. The method of claim 20, wherein the ordering of the non-zero coefficients includes ordering coefficients of the permuted version of the coefficient of all time domain indices and spatial domain indices for each respective frequency domain index of the permuted version of the coefficient matrix.

23. The method of claim 20, wherein the coefficient matrix is associated with one or more sets of coefficients, wherein each set, from the one or more sets, is associated with a respective frequency domain basis index, and wherein each set includes columns for time domain basis indices associated with the coefficient matrix and rows for spatial domain basis indices associated with the coefficient matrix, and
wherein the ordering of the non-zero coefficients includes ordering coefficients of the permuted version of the coefficient matrix by ordering coefficients for the rows for the spatial domain basis indices, and the one or more sets, associated with each respective column, of the columns for the time domain basis indices, in an order of the columns.

24. The method of claim 20, wherein the coefficient matrix is associated with one or more sets of coefficients, wherein each set, from the one or more sets, is associated with a frequency domain basis index, and wherein each set includes columns for time domain basis indices associated with the coefficient matrix and rows for spatial domain basis indices associated with the coefficient matrix, and
wherein the ordering of the non-zero coefficients includes ordering coefficients of the permuted version of the coefficient matrix by ordering coefficients for the rows for the spatial domain basis indices and the columns for the time domain basis indices for each respective set of the one or more sets in an order of the one or more sets.

25. The method of claim 20, wherein the coefficient matrix is associated with one or more sets of coefficients, wherein each set, from the one or more sets, is associated with a time domain basis index, and wherein each set includes columns for frequency domain basis indices associated with the coefficient matrix and rows for spatial domain basis indices associated with the coefficient matrix, and
wherein the ordering of the non-zero coefficients includes ordering coefficients of the permuted version of the coefficient matrix by ordering coefficients for the rows for the spatial domain basis indices and the columns for the frequency domain basis indices for each respective set of the one or more sets in an order of the one or more sets.

26. The method of claim 16, wherein a size of the uplink resource is insufficient for the CSI report, and wherein transmitting the UCI comprises refraining from including one or more PMI values, from the PMI values, based at least in part on omitting information associated with at least one group from the groups based at least in part on prioritizing the groups.

27. The method of claim 26, wherein the UCI is associated with multiple CSI reports, including the CSI report, and wherein refraining from including the one or more PMI values is based at least in part on prioritizing CSI reports, from the multiple CSI reports, in an order of index values of the multiple CSI reports.

28. A method of wireless communication performed by a network node, comprising:
transmitting an indication of an uplink resource, intended for a user equipment (UE), associated with reporting channel state information (CSI); and
receiving uplink control information (UCI) associated with the UE and the uplink resource, the UCI including a CSI report that indicates precoding matrix indicator (PMI) values, the UCI being associated with groups for prioritization of information associated with the CSI report, at least one group, of the groups, being associated with time domain basis index values and non-zero coefficients of a coefficient matrix.

29. The method of claim 28, wherein the groups include a first group that is associated with spatial domain beam index values and strongest coefficient index values; a second group that is associated with frequency domain index values, the time domain index values, and a first portion of the non-zero coefficients; and a third group that is associated with a second portion of the non-zero coefficients of the coefficient matrix, wherein the at least one group is the second group.

30. The method of claim 28, wherein a prioritization of the non-zero coefficients includes ordering the non-zero coefficients based at least in part on a permuted version of the coefficient matrix, wherein the permuted version includes at least one of a time domain permutation and a frequency domain permutation, and wherein the ordering of the non-zero coefficients includes ordering coefficients of the permuted version of the coefficient matrix by ordering time domain indices and spatial domain indices for each respective frequency domain index of the permuted version of the coefficient matrix.
